(19) United States
(12) Patent Application Publication
(10) Pub. No.: US 2010/0165280 A1
(43) Pub. Date: Jul. 1, 2010

(54) LIQUID CRYSTAL DISPLAY DEVICE

(75) Inventors: Tetsuji ISHITANI, Isehara (JP); Daisuke KUBOTA, Isehara (JP); Takeshi NISHI, Atsugi-Kanagawa (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/640,161

(22) Filed: Dec. 17, 2009

(30) Foreign Application Priority Data
Dec. 25, 2008 (JP) 2008-329656

(51) Int. Cl. G02F 1/1343

(52) U.S. Cl. 349/141

(57) ABSTRACT

It is an object to provide a liquid crystal display device using a liquid crystal material exhibiting a blue phase which enables higher contrast. In the liquid crystal display device including a liquid crystal layer exhibiting a blue phase, the liquid crystal layer exhibiting a blue phase is interposed between a pixel electrode layer having an opening pattern and a common electrode layer having an opening pattern (a slit). An electric field is applied between the pixel electrode layer and the common electrode layer which have opening patterns and are provided so that a liquid crystal is interposed therebetween, whereby an oblique (oblique to a substrate) electric field is applied to the liquid crystal. Thus, liquid crystal molecules can be controlled by the electric field.

### BACKGROUND OF THE INVENTION

1. Field of the Invention

The present invention relates to a liquid crystal display device and a method for manufacturing the liquid crystal display device.

2. Description of the Related Art

As a display device which is thin and lightweight (a so-called flat panel display), a liquid crystal display device including a liquid crystal element, a light-emitting device including a self light-emitting element, a field emission display (an FED), and the like have been competitively developed.

In a liquid crystal display device, response speed of liquid crystal molecules is required to be increased. Among various kinds of display modes of a liquid crystal, a ferroelectric liquid crystal (FLC) mode, an optical compensated birefringence (OCB) mode, and a mode using a liquid crystal exhibiting a blue phase can be given as liquid crystal modes by which high-speed response is possible.

In particular, the mode using a liquid crystal exhibiting a blue phase does not require an alignment film and the viewing angle can be widened; therefore, further research thereon has been carried out for practical use (see Patent Document 1, for example). Patent Document 1 is a report that polymer stabilization treatment is performed on a liquid crystal to widen a temperature range in which a blue phase appears.

[Reference]

[Patent Document 1] PCT International Publication No. 05/090520

In order to achieve high contrast of a liquid crystal display device, white transmittance (light transmittance in white display) needs to be high.

Therefore, it is an object to provide a liquid crystal display device that is suitable for a liquid crystal display mode using a liquid crystal exhibiting a blue phase in order to obtain higher contrast.

### SUMMARY OF THE INVENTION

In a liquid crystal display device including a liquid crystal layer exhibiting a blue phase, the liquid crystal layer exhibiting a blue phase is interposed between a pixel electrode layer having an opening pattern and a common electrode layer having an opening pattern (a slit).

The pixel electrode layer formed over a first substrate (also referred to as an element substrate) and the common electrode layer formed on a second substrate (also referred to as a counter substrate) are firmly attached to each other by a sealant with the liquid crystal layer interposed between the electrode layers. The pixel electrode layer and the common electrode layer do not have flat shapes but have various opening patterns, and each have a shape including a bending portion or a branching-comb shape.

An electric field is applied between the pixel electrode layer and the common electrode layer which have the opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In this specification, the opening patterns (slits) of the pixel electrode layer and the common electrode layer include a partially opened pattern such as a comb shape in addition to a pattern opened in a closed space.

In this specification, a substrate over which a thin film transistor, a pixel electrode layer, and an interlayer film are formed is referred to as an element substrate (a first substrate), and a substrate provided with a common electrode layer (also referred to as a counter electrode layer) which faces the element substrate with a liquid crystal layer interposed therebetween is referred to as a counter substrate (a second substrate).

A liquid crystal material exhibiting a blue phase is used for the liquid crystal layer. The liquid crystal material exhibiting a blue phase has a short response time of 1 msec or less and enables high-speed response, whereby the liquid crystal display device can have higher performance.

The liquid crystal material exhibiting a blue phase includes a liquid crystal and a chiral agent. The chiral agent is employed to align the liquid crystal in a helical structure and to make the liquid crystal to exhibit a blue phase. For example, a liquid crystal material into which a chiral agent is mixed at 5 wt % or more may be used for the liquid crystal layer.

As the liquid crystal, a thermotropic liquid crystal, a low-molecular liquid crystal, a high-molecular liquid crystal, a ferroelectric liquid crystal, an anti-ferroelectric liquid crystal, or the like is used.

As the chiral agent, a material having a high compatibility with a liquid crystal and a strong twisting power is used. Either one of two enantiomers, R and S, is used, and a racemic mixture in which R and S are mixed at 50:50 is not used.

The above liquid crystal material exhibits a cholesteric phase, a cholesteric blue phase, a smectic phase, a smectic blue phase, a cubic phase, a chiral nematic phase, an isotropic phase, or the like depending on conditions.

A cholesteric blue phase and a smectic blue phase, which are blue phases, are seen in a liquid crystal material having a cholesteric phase or a smectic phase with a relatively short helical pitch of less than or equal to 500 nm. The alignment of the liquid crystal material has a double twist structure. Having the order of less than or equal to an optical wavelength, the liquid crystal material is transparent, and optical modulation action is generated through a change in alignment order by voltage application. A blue phase is optically isotropic and thus has no viewing angle dependence. Thus, an alignment film is not necessarily formed; therefore, display image quality can be improved and cost can be reduced.

Since the blue phase is exhibited only in a narrow temperature range, it is preferable that a photocurable resin and a photopolymerization initiator be added to a liquid crystal material and that polymer stabilization treatment be performed in order to widen the temperature range. The polymer stabilization treatment is performed in such a manner that a liquid crystal material including a liquid crystal, a chiral agent, a photocurable resin, and a photopolymerization initiator is irradiated with light having a wavelength with which the photocurable resin and the photopolymerization initiator react. This polymer stabilization treatment may be performed by irradiating a liquid crystal material exhibiting an isotropic phase with light, or by irradiating a liquid crystal material exhibiting a blue phase under the control of the temperature, with light. For example, the polymer stabilization treatment is performed in the following manner: the temperature of the liquid crystal layer is controlled and under the state in which the blue phase is exhibited, the liquid crystal layer is irradiated with light. However, the polymer stabilization treatment is not limited to this manner and may be performed in such a manner that a liquid crystal layer under the state of exhibiting an isotropic phase at a temperature within +10° C., preferably +5° C. of the phase transition temperature between the blue phase and the isotropic phase is irradiated with light. The phase transition temperature between the blue phase and the isotropic phase is a temperature at which the phase changes from the blue phase to the isotropic phase when the temperature rises, or a temperature at which the phase changes from the isotropic phase to the blue phase when the temperature decreases. As an example of the polymer stabilization treatment, the following method can be employed: after heating a liquid crystal layer to exhibit the isotropic phase, the temperature of the liquid crystal layer is gradually decreased so that the phase changes to the blue phase, and then, irradiation with light is performed while the temperature at which the blue phase is exhibited is kept. Alternatively, after the phase changes to the isotropic phase by gradually heating a liquid crystal layer, the liquid crystal layer can be irradiated with light under a temperature within +10° C., preferably +5° C. of the phase transition temperature between the blue phase and the isotropic phase (under the state of exhibiting an isotropic phase). In the case of using an ultraviolet curable resin (a UV curable resin) as a photocurable resin included in the liquid crystal material, the liquid crystal layer may be irradiated with ultraviolet rays. Even in the case where the blue phase is not exhibited, if polymer stabilization treatment is performed by irradiation with light under a temperature within +10° C., preferably +5° C. of the phase transition temperature between the blue phase and the isotropic phase (under the state of exhibiting an isotropic phase), the response time can be made as short as 1 msec or less and high-speed response is possible.

One embodiment of the structure of the invention disclosed in this specification includes a first substrate and a second substrate between which a liquid crystal layer including a liquid crystal material exhibiting a blue phase is interposed; a pixel electrode layer having an opening pattern, which is provided between the first substrate and the liquid crystal layer; and a common electrode layer having an opening pattern, which is provided between the second substrate and the liquid crystal layer.

Another embodiment of the structure of the invention disclosed in this specification includes a first substrate and a second substrate between which a liquid crystal layer including a liquid crystal material exhibiting a blue phase is interposed; a pixel electrode layer having an opening pattern, which is provided between the first substrate and the liquid crystal layer; and a common electrode layer having an opening pattern, which partially overlaps with the pixel electrode layer and is provided between the second substrate and the liquid crystal layer.

Since the liquid crystal layer exhibiting a blue phase is used, an alignment film does not need to be formed; therefore, the pixel electrode layer is in contact with the liquid crystal layer and the common electrode layer is also in contact with the liquid crystal layer.

In the above structure, a thin film transistor is provided between the first substrate and the pixel electrode layer, and the pixel electrode layer is electrically connected to the thin film transistor.

An oxide semiconductor layer can be used as a semiconductor layer of the thin film transistor; for example, an oxide semiconductor layer containing at least one of indium, zinc, and gallium can be given.

When a blue-phase liquid crystal material is used, rubbing treatment on an alignment film is unnecessary; accordingly, electrostatic discharge damage caused by the rubbing treatment can be prevented and defects and damage of the liquid crystal display device in the manufacturing process can be reduced. Thus, productivity of the liquid crystal display device can be increased. A thin film transistor that uses an oxide semiconductor layer particularly has a possibility that electric characteristics of the thin film transistor may fluctuate significantly by the influence of static electricity and deviate from the designed range. Therefore, it is more effective to use a blue-phase liquid crystal material for a liquid crystal display device including a thin film transistor that uses an oxide semiconductor layer.

Note that the ordinal numbers such as “first” and “second” in this specification are used for convenience and do not denote the order of steps and the stacking order of layers. In addition, the ordinal numbers in this specification do not denote particular names which specify the invention.

In this specification, a semiconductor device refers to all types of devices which can function by utilizing semiconductor characteristics. Electro-optical device, semiconductor circuits, and electronic devices are all semiconductor devices.

In a liquid crystal display device using a liquid crystal layer exhibiting a blue phase, contrast ratio can be increased.

### BRIEF DESCRIPTION OF THE DRAWINGS

In the accompanying drawings:

FIGS. 1A and 1B are views illustrating electric field modes of liquid crystal display devices;

FIGS. 2A and 2B are views illustrating a liquid crystal display device;

FIGS. 3A and 3B are views illustrating a liquid crystal display device;

FIGS. 4A and 4B are views illustrating a liquid crystal display device;

FIGS. 5A and 5B are views illustrating a liquid crystal display device;

FIGS. 6A and 6B are views illustrating a liquid crystal display device;

FIGS. 7A to 7D are views illustrating a method for manufacturing a liquid crystal display device;

FIGS. 8A to 8D are views each illustrating electrode layers of a liquid crystal display device;

FIGS. 9A and 9B are views illustrating a liquid crystal display device;

FIGS. 10A and 10B are views illustrating a liquid crystal display device;

FIGS. 11A and 11B are views illustrating a liquid crystal display device;

FIGS. 12A1, 12A2, and 12B are views illustrating a liquid crystal display device;

FIGS. 13A and 13B are external views respectively illustrating an example of a television set and a digital photo frame;

FIGS. 14A and 14B are external views illustrating examples of amusement machines;

FIGS. 15A and 15B are external views illustrating examples of cellular phones;

FIG. 16 is a view illustrating a liquid crystal display module;

FIGS. 17A to 17D are views illustrating a method for manufacturing a liquid crystal display device;

FIGS. 18A and 18B are graphs showing results of calculating electric field modes of liquid crystal display devices; and

FIG. 19 is a graph showing a result of calculating an electric field mode of a liquid crystal display device.

### DETAILED DESCRIPTION OF THE INVENTION

Embodiments will be described in detail with reference to the drawings. Note that the present invention is not limited to description below and it can be easily understood by those skilled in the art that the mode and the detail can be changed variously without departing from the sprit and scope of the invention. Therefore, the present invention should not be interpreted as being limited to the description of the embodiments below. Note that in the structures described below, the same reference numerals will be commonly used for the same portions and portions having similar functions in the different drawings, and repetitive explanation thereof will be omitted.

### Embodiment 1

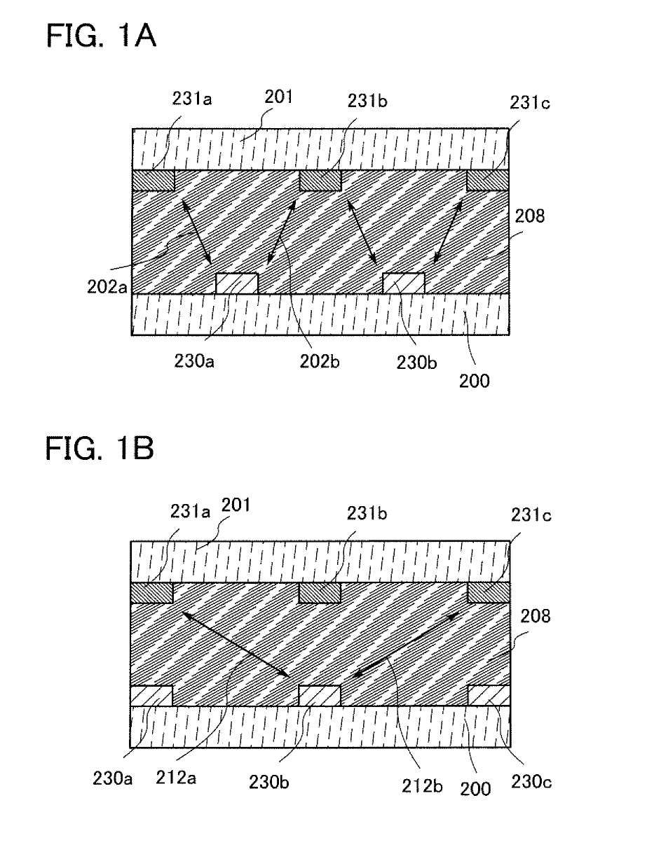

Liquid crystal display devices will be described with reference to FIGS. 1A and 1B, FIGS. 18A and 18B, and FIG. 19.

FIGS. 1A and 1B are cross-sectional views of the liquid crystal display devices.

FIG. 1A illustrates a liquid crystal display device in which a first substrate 200 and a second substrate 201 are arranged so as to face each other with a liquid crystal layer 208 including a liquid crystal material exhibiting a blue phase interposed therebetween. Pixel electrode layers 230a and 230b are provided between the first substrate 200 and the liquid crystal layer 208. Common electrode layers 231a, 231b, and 231c are formed between the second substrate 201 and the liquid crystal layer 208.

The pixel electrode layers 230a and 230b and the common electrode layers 231a, 231b, and 231c do not have flat shapes but have shapes with opening patterns; therefore, the pixel electrode layers 230a and 230b and the common electrode layers 231a, 231b, and 231c are illustrated as a plurality of divided electrode layers in the cross-sectional view.

FIG. 1A illustrates an example in which the pixel electrode layers 230a and 230b and the common electrode layers 231a. 231b and 231c are provided alternately so as not to overlap with each other with the liquid crystal layer 208 interposed therebetween in the cross section.

The pixel electrode layers and the common electrode layers may be arranged so as to overlap with each other with the liquid crystal layer interposed therebetween, and may have shapes similar to each other in a pixel region. FIG. 1B illustrates an example in which the pixel electrode layers 230a and 230b, and a pixel electrode layer 230c are provided so as to overlap with the common electrode layers 231a, 231b, and 231c, respectively.

In each of the liquid crystal display devices of FIGS. 1A and 1B, the pixel electrode layer and the common electrode layer have opening patterns, and the pixel electrode layer and the common electrode layer are arranged with the liquid crystal layer 208 interposed therebetween; therefore, in applying an electric field, an oblique (oblique to the substrates) electric field is applied to the liquid crystal layer 208. Such an oblique electric field can be used for controlling liquid crystal molecules.

In FIG. 1A, for example, an oblique electric field is applied between the pixel electrode layer 230a and the common electrode layer 231a as indicated by an arrow 202a, and an oblique electric field is applied between the pixel electrode layer 230a and the common electrode layer 231b as indicated by an arrow 202b. In FIG. 1B, an oblique electric field is applied between the pixel electrode layer 230b and the common electrode layer 231a as indicated by an arrow 212a, and an oblique electric field is applied between the pixel electrode layer 230b and the common electrode layer 231c as indicated by an arrow 212b.

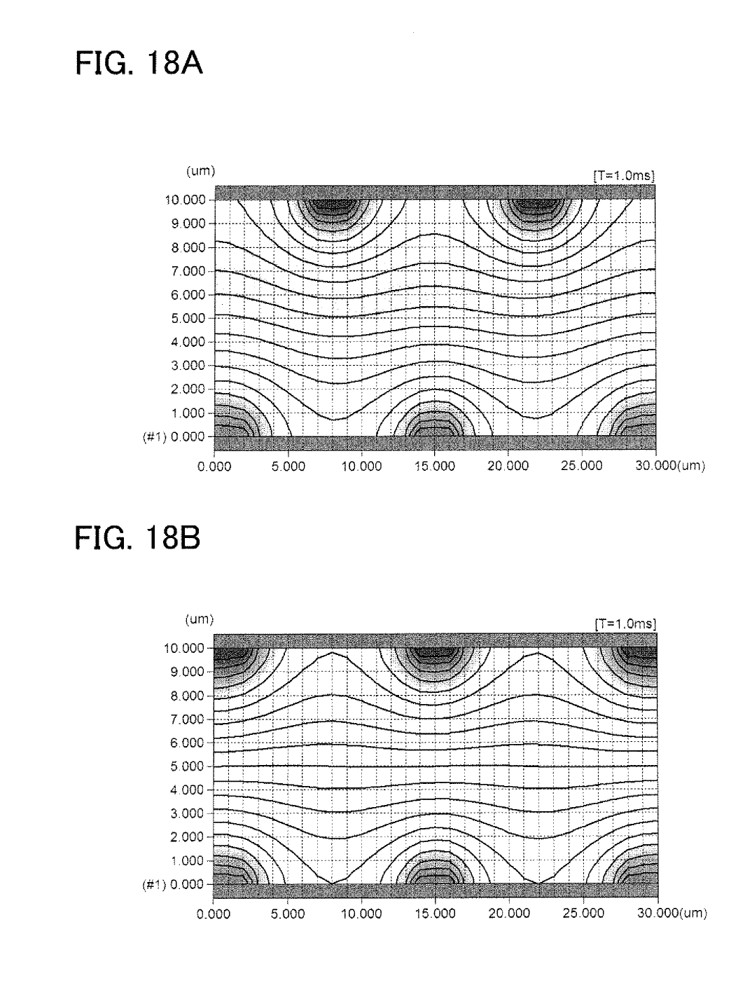

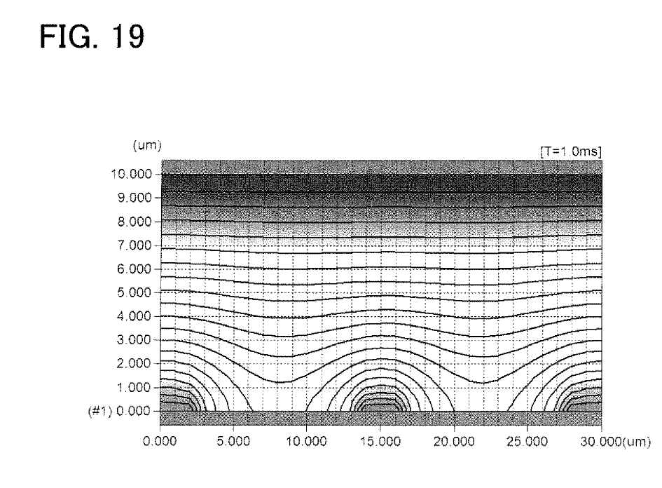

FIGS. 18A and 18B, and FIG. 19 show calculation results of electric-field application state in the liquid crystal display devices. The calculation is performed using LCD Master, 2s Bench manufactured by SHINTECH, Inc. Widths of the pixel electrode layers and the common electrode layers in the cross section are each 2 μm, thicknesses thereof are each 0.1 μm, the distance between the pixel electrode layers is 12 μm, the distance between the common electrode layers is 12 μm, and the thickness of the liquid crystal layer is 10 μm. In FIG. 18A, the misalignment distance between the pixel electrode layer and the common electrode layer in the direction parallel to the substrates is 5 μm. Note that the common electrode layer provided on the upper substrate in the drawing is set at 0 V and the pixel electrode layer provided over the lower substrate is set at 10 V.

FIGS. 18A and 18B show the calculation results for FIGS. 1A and 1B, respectively. Further, FIG. 19 shows a calculation result of a comparative example in which a pixel electrode layer on the lower side has a shape with an opening pattern and a common electrode layer on the upper side has a flat shape at least in a pixel region. In FIGS. 18A and 18B, and FIG. 19, a solid line shows an equipotential line, and the pixel electrode layer or the common electrode layer is arranged in the center of a circular pattern of the equipotential lines.

Since an electric field appears perpendicularly to the equipotential line, application of an oblique electric field between the pixel electrode layers and the common electrode layers can be observed as shown in FIGS. 18A and 18B.

On the other hand, from FIG. 19, which is the case of using the common electrode layer having a flat shape, the following state can be observed: as the equipotential lines are closer to the upper common electrode layer, the equipotential lines are likely to be parallel to a surface of a substrate; that is, the oblique electric field does not appear. Therefore, with the pixel electrode layer and the common electrode layer which are provided with the liquid crystal layer interposed therebetween and have the opening patterns, the oblique electric field can be applied to the whole liquid crystal layer; accordingly, all liquid crystal molecules can be made to respond.

In a liquid crystal display device, white transmittance is determined by the product of the thickness of a liquid crystal layer and birefringence of a liquid crystal, which is generated when voltage is applied; therefore, even when the thickness of the liquid crystal layer is large, liquid crystal molecules in the whole liquid crystal layer can be made to respond.

Accordingly, when an oblique electric field is applied to the liquid crystal layer, the liquid crystal molecules in the whole liquid crystal layer including the liquid crystal molecules in the thickness direction can be made to respond, so that white transmittance is improved. Thus, contrast ratio, which is a ratio of white transmittance to black transmittance (light transmittance in black display), can also be increased.

As a method for forming the liquid crystal layer 208, a dispenser method (a dropping method) or an injecting method by which a liquid crystal is injected using a capillary phenomenon after bonding the first substrate 200 and the second substrate 201 to each other can be used.

A liquid crystal material exhibiting a blue phase is used for the liquid crystal layer 208. The liquid crystal material exhibiting a blue phase has a short response time of I msec or less and enables high-speed response. Accordingly, the liquid crystal display device can have higher performance.

The liquid crystal material exhibiting a blue phase includes a liquid crystal and a chiral agent. The chiral agent is employed to align the liquid crystal in a helical structure and to make the liquid crystal to exhibit a blue phase. For example, a liquid crystal material into which a chiral agent is mixed at 5 wt % or more may be used for the liquid crystal layer.

As the liquid crystal, a thermotropic liquid crystal, a low-molecular liquid crystal, a high-molecular liquid crystal, a ferroelectric liquid crystal, an anti-ferroelectric liquid crystal, or the like is used.

As the chiral agent, a material having a high compatibility with a liquid crystal and a strong twisting power is used. Either one of two enantiomers, R and S, is used, and a racemic mixture in which R and S are mixed at 50:50 is not used.

The above liquid crystal material exhibits a cholesteric phase, a cholesteric blue phase, a smectic phase, a smectic blue phase, a cubic phase, a chiral nematic phase, an isotropic phase, or the like depending on conditions.

A cholesteric blue phase and a smectic blue phase, which are blue phases, are seen in a liquid crystal material having a cholesteric phase or a smectic phase with a relatively short helical pitch of less than or equal to 500 nm. The alignment of the liquid crystal material has a double twist structure. Having the order of less than or equal to an optical wavelength, the liquid crystal material is transparent, and optical modulation action is generated through a change in alignment order by voltage application.

Since the blue phase is exhibited only in a narrow temperature range, it is preferable that a photocurable resin and a photopolymerization initiator be added to a liquid crystal material and that polymer stabilization treatment be performed in order to widen the temperature range. The polymer stabilization treatment is performed in such a manner that a liquid crystal material including a liquid crystal, a chiral agent, a photocurable resin, and a photopolymerization initiator is irradiated with light having a wavelength with which the photocurable resin and the photopolymerization initiator react. This polymer stabilization treatment may be performed by irradiating a liquid crystal material exhibiting an isotropic phase with light, or by irradiating a liquid crystal material exhibiting a blue phase under the control of the temperature, with light. For example, the polymer stabilization treatment is performed in the following manner: the temperature of the liquid crystal layer is controlled and under the state in which the blue phase is exhibited, the liquid crystal layer is irradiated with light. However, the polymer stabilization treatment is not limited to this manner and may be performed in such a manner that a liquid crystal layer under the state of exhibiting an isotropic phase at a temperature within +10° C., preferably +5° C. of the phase transition temperature between the blue phase and the isotropic phase is irradiated with light. The phase transition temperature between the blue phase and the isotropic phase is a temperature at which the phase changes from the blue phase to the isotropic phase when the temperature rises, or a temperature at which the phase changes from the isotropic phase to the blue phase when the temperature decreases. As an example of the polymer stabilization treatment, the following method can be employed: after heating a liquid crystal layer to exhibit the isotropic phase, the temperature of the liquid crystal layer is gradually decreased so that the phase changes to the blue phase, and then, irradiation with light is performed while the temperature at which the blue phase is exhibited is kept. Alternatively, after the phase changes to the isotropic phase by gradually heating a liquid crystal layer, the liquid crystal layer can be irradiated with light under a temperature within +10° C., preferably +5° C. of the phase transition temperature between the blue phase and the isotropic phase (under the state of exhibiting an isotropic phase). In the case of using an ultraviolet curable resin (a UV curable resin) as a photocurable resin included in the liquid crystal material, the liquid crystal layer may be irradiated with ultraviolet rays. Even in the ease where the blue phase is not exhibited, if polymer stabilization treatment is performed by irradiation with light under a temperature within +10° C., preferably +5° C. of the phase transition temperature between the blue phase and the isotropic phase (under the state of exhibiting an isotropic phase), the response time can be made as short as 1 msec or less and high-speed response is possible.

The photocurable resin may be a mono functional monomer such as acrylate or methacrylate; a polyfunctional monomer such as diacrylate, triacrylate, dimethacrylate, or trimethacrylate; or a mixture thereof. Further, the photocurable resin may have liquid crystallinity, non-liquid crystallinity, or both of them. A resin which is cured with light having a wavelength with which the photopolymerization initiator to be used reacts may be selected as the photocurable resin, and an ultraviolet curable resin can be typically used.

As the photopolymerization initiator, a radical polymerization initiator which generates radicals by light irradiation, an acid generator which generates an acid by light irradiation, or a base generator which generates a base by light irradiation may be used.

Specifically, a mixture of JC-1041XX (produced by Chisso Corporation) and 4-cyano-4′-pentylbiphenyl can be used as the liquid crystal material. ZLI-4572 (produced by Merck Ltd., Japan) can be used as the chiral agent. As the photocurable resin, 2-ethylhexyl acrylate, RM257 (produced by Merck Ltd., Japan), or trimethylolpropane triacrylate can be used. As the photopolymerization initiator, 2,2-dimethoxy-2-phenylacetophenone can be used.

Although not illustrated in FIGS. 1A and 1B, an optical film such as a polarizing plate, a retardation plate, or an anti-reflection film, or the like is provided as appropriate. For example, circular polarization using a polarizing plate and a retardation plate may be employed. Further, a backlight, a sidelight, or the like may be used as a light source.

In this specification, when the liquid crystal display device is a transmissive liquid crystal display device (or a semi-transmissive liquid crystal display device) in which display is performed by transmitting light from a light source, light needs to be transmitted at least in the pixel region. Therefore, the first substrate, the second substrate, and thin films such as an insulating film and a conductive film that exist in the pixel region through which the light passes all have a light-transmitting property with respect to light in a visible wavelength range.

The pixel electrode layer and the common electrode layer preferably have a light-transmitting property; however, a non-light-transmitting material such as a metal film may also be used because the pixel electrode layer and the common electrode layer have the opening patterns.

The pixel electrode layer and the common electrode layer can be formed using one kind or plural kinds of the following: indium tin oxide (ITO), indium zinc oxide (IZO) in which zinc oxide (ZnO) is mixed into indium oxide, a conductive material in which silicon oxide (SiO₂) is mixed into indium oxide, organoindium, organotin, indium oxide containing tungsten oxide, indium zinc oxide containing tungsten oxide, indium oxide containing titanium oxide, or indium tin oxide containing titanium oxide; metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), or silver (Ag); an alloy thereof; or a nitride thereof.

As the first substrate 200 and the second substrate 201, a glass substrate of barium borosilicate glass, aluminoborosilicate glass, or the like, a quartz substrate, a plastic substrate, or the like can be used.

In the above-described manner, in the liquid crystal display device using the liquid crystal layer exhibiting a blue phase, contrast ratio can be increased.

### Embodiment 2

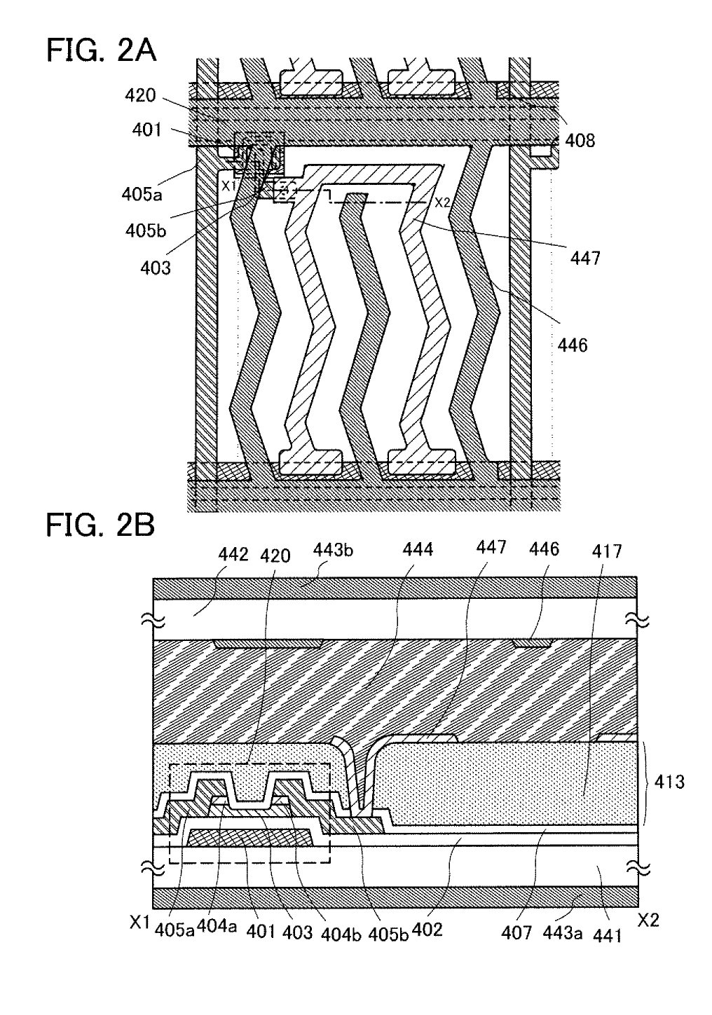

The invention disclosed in this specification can be applied to both a passive matrix liquid crystal display device and an active matrix liquid crystal display device. An example of the active matrix liquid crystal display device will be described with reference to FIGS. 2A and 2B.

FIG. 2A is a plan view of the liquid crystal display device and illustrates one pixel. FIG. 2B is a cross-sectional view taken along line X1-X2 in FIG. 2A.

In FIG. 2A, a plurality of source wiring layers (including a wiring layer 405a) is arranged so as to be parallel to (extend in a vertical direction in the drawing) and apart from each other. A plurality of gate wiring layers (including a gate electrode layer 401) is arranged so as to extend in a direction generally perpendicular to the source wiring layers (in a horizontal direction in the drawing) and be apart from each other. Capacitor wiring layers 408 are arranged adjacent to the plurality of gate wiring layers and extend in a direction generally parallel to the gate wiring layers, that is, in a direction generally perpendicular to the source wiring layers (in the horizontal direction in the drawing). A roughly rectangular space is surrounded by the source wiring layers, the capacitor wiring layer 408, and the gate wiring layers. In this space, a pixel electrode layer and a common electrode layer of the liquid crystal display device are arranged with a liquid crystal layer 444 interposed therebetween. A thin film transistor 420 for driving the pixel electrode layer is arranged on an upper left corner in the drawing. A plurality of pixel electrode layers and thin film transistors are arranged in matrix.

In the liquid crystal display device in FIGS. 2A and 2B, a first electrode layer 447 which is electrically connected to the thin film transistor 420 functions as the pixel electrode layer, and a second electrode layer 446 functions as the common electrode layer. Note that a capacitor is formed by the first electrode layer 447 and the capacitor wiring layer 408. Although the common electrode layer can operate in a floating state (an electrically isolated state), the potential of the common electrode layer may be set to a fixed potential, preferably to a potential around a common potential (an intermediate potential of an image signal which is transmitted as data) in such a level as not to generate flickers.

The first electrode layer 447 which is the pixel electrode layer formed over a first substrate 441 (also referred to as an element substrate), and the second electrode layer 446 which is the common electrode layer formed on a second substrate 442 (also referred to as a counter substrate) are firmly attached to each other by a sealant with the liquid crystal layer 444 interposed between the electrode layers. The first electrode layer 447 and the second electrode layer 446 do not have flat shapes but have various opening patterns, and each have a shape including a bending portion or a branching-comb shape.

An electric field is applied between the first electrode layer 447 and the second electrode layer 446 which have the opening patterns and are provided so that the liquid crystal layer 444 is interposed therebetween, whereby an oblique (oblique to the substrates) electric field is applied to a liquid crystal. Thus, liquid crystal molecules can be controlled by the electric field. When the oblique electric field is applied to the liquid crystal layer 444, the liquid crystal molecules in the whole liquid crystal layer 444 including the liquid crystal molecules in the thickness direction can be made to respond, so that white transmittance is improved. Accordingly, contrast ratio, which is a ratio of white transmittance to black transmittance (light transmittance in black display), can also be increased.

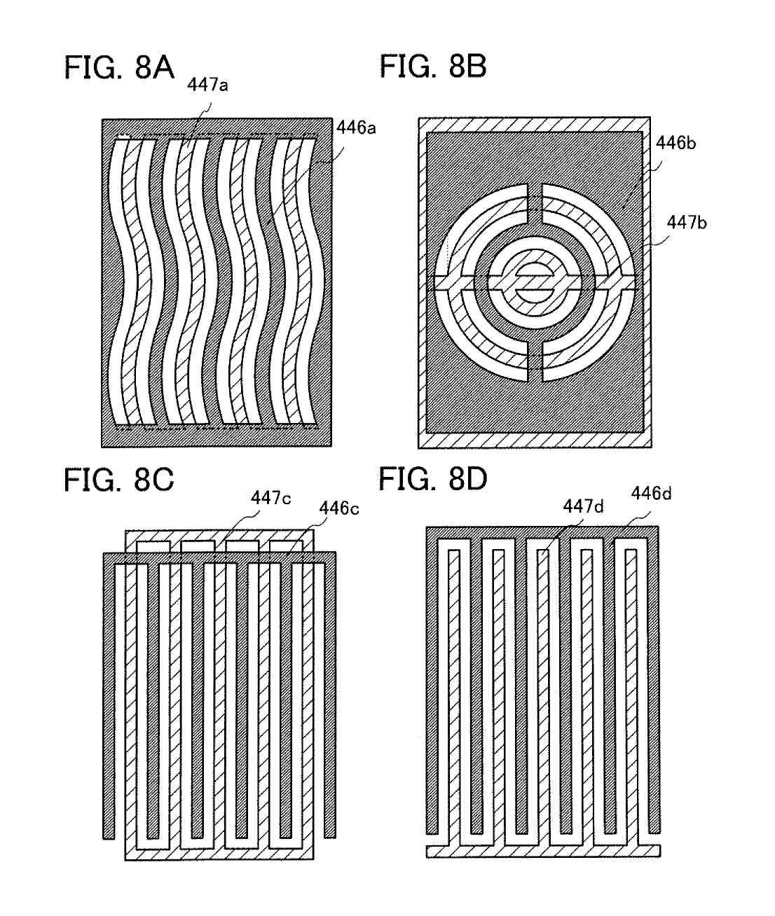

Other examples of the first electrode layer 447 and the second electrode layer 446 are illustrated in FIGS. 8A to 8D. Although omitted in the figures, the liquid crystal layer 444 is interposed between the first electrode layer 447 and the second electrode layer 446. As illustrated in the top views of FIGS. 8A to 8D, first electrode layers 447a to 447d and second electrode layers 446a to 446d are arranged alternately. In FIG. 8A, the first electrode layer 447a and the second electrode layer 446a have wavelike shapes with curves. In FIG. 8B, the first electrode layer 447b and the second electrode layer 446b have a shape with concentric circular openings. In FIG. 8C, the first electrode layer 447e and the second electrode layer 446c have comb shapes and partially overlap with each other. In FIG. 8D, the first electrode layer 447d and the second electrode layer 446d have comb shapes in which the electrode layers are engaged with each other.

The thin film transistor 420 is an inversely-staggered thin film transistor, and includes, over the first substrate 441 which is a substrate having an insulating surface, the gate electrode layer 401, a gate insulating layer 402, a semiconductor layer 403, n⁺ layers 404a and 404b functioning as a source region and a drain region, and wiring layers 405a and 405b functioning as a source electrode layer and a drain electrode layer. The n⁺ layers 404a and 404b are semiconductor layers having lower resistance than the semiconductor layer 403.

An insulating film 407 is provided in contact with the semiconductor layer 403 so as to cover the thin film transistor 420. An interlayer film 413 is provided over the insulating film 407, the first electrode layer 447 is formed over the interlayer film 413, and the second electrode layer 446 is formed with the liquid crystal layer 444 interposed between the electrode layers.

The liquid crystal display device can be provided with a coloring layer which functions as a color filter layer. The color filter layer may be provided on the outside (a side opposite to the liquid crystal layer 444) of the first substrate 441 and the second substrate 442, or may be provided on the inside of the first substrate 441 and the second substrate 442.

When full-color display is performed in the liquid crystal display device, the color filter may be formed of materials exhibiting red (R), green (G), and blue (B). When monochrome display is performed, the coloring layer may be omitted or formed of a material exhibiting at least one color. Note that the color filter is not always provided in the case where light-emitting diodes (LEDs) of RGB or the like are arranged in a backlight unit and a successive additive color mixing method (a field sequential method) in which color display is performed by time division is employed.

The liquid crystal display device in FIGS. 2A and 2B is an example in which a light-transmitting chromatic color resin layer 417 functioning as the color filter layer is used for the interlayer film 413.

In the case of providing a color filter layer on the counter substrate side, precise positional alignment of a pixel region with an element substrate over which a thin film transistor is formed is difficult and accordingly there is a possibility that image quality is degraded. Here, since the interlayer film is formed as the color filter layer directly on the element substrate side, the formation region can be controlled more precisely and this structure is adjustable to a pixel with a fine pattern. In addition, one insulating layer can serve as both the interlayer film and the color filter layer, whereby the process can be simplified and a liquid crystal display device can be manufactured at lower cost.

As the light-transmitting chromatic color resin, a photosensitive or nonphotosensitive organic resin can be used. A photosensitive organic resin layer is preferably used because the number of resist masks can be reduced and thus process can be simplified. In addition, a contact hole formed in the interlayer film has an opening shape with curvature, whereby coverage by a film formed in the contact hole, such as an electrode layer can be improved.

Chromatic colors are colors except achromatic colors such as black, gray, and white. The coloring layer is formed of a material that transmits only light of a chromatic color which the material is colored in so as to function as the color filter. As a chromatic color, red, green, blue, or the like can be used. Alternatively, cyan, magenta, yellow, or the like may also be used. “Transmitting only light of a chromatic color which a material is colored in” means that light transmitted through the coloring layer has a peak at the wavelength of the chromatic color light.

In order that the light-transmitting chromatic color resin layer 417 functions as a coloring layer (a color filter), the thickness thereof is preferably adjusted as appropriate to be the most suitable thickness in consideration of the relation between the concentration of a coloring material to be contained and light transmittance. In the case where the interlayer film 413 is formed by stacking a plurality of thin films, at least one layer thereof needs to be a light-transmitting chromatic color resin layer so that the interlayer film 413 can function as a color filter.

In the case where the thickness of the light-transmitting chromatic color resin layer varies depending on the chromatic colors, or in the case where there is surface unevenness due to a light-blocking layer or a thin film transistor, an insulating layer which transmits light in a visible wavelength range (a so-called colorless transparent insulating layer) may be stacked so that the surface of the interlayer film is planarized. When planarity of the interlayer film is increased, coverage by a pixel electrode layer or a common elector layer to be formed thereover is favorable and the gap (the thickness) of a liquid crystal layer can be uniform; accordingly, visibility of the liquid crystal display device can be further improved and higher image quality can be obtained.

There is no particular limitation on the method for forming the interlayer film 413 (the light-transmitting chromatic color resin layer 417), and the following method can be employed in accordance with the material: spin coating, dip coating, spray coating, droplet discharging (such as ink jetting, screen printing, or offset printing), a doctor knife, a roll coater, a curtain coater, a knife coater, or the like.

The liquid crystal layer 444 is provided over the first electrode layer 447 and sealed with the second substrate 442 that is a counter substrate on which the second electrode layer 446 is formed.

The first substrate 441 and the second substrate 442 are light-transmitting substrates and are provided with a polarizing plate 443a and a polarizing plate 443b on the outsides (sides opposite to the liquid crystal layer 444) of the substrates, respectively.

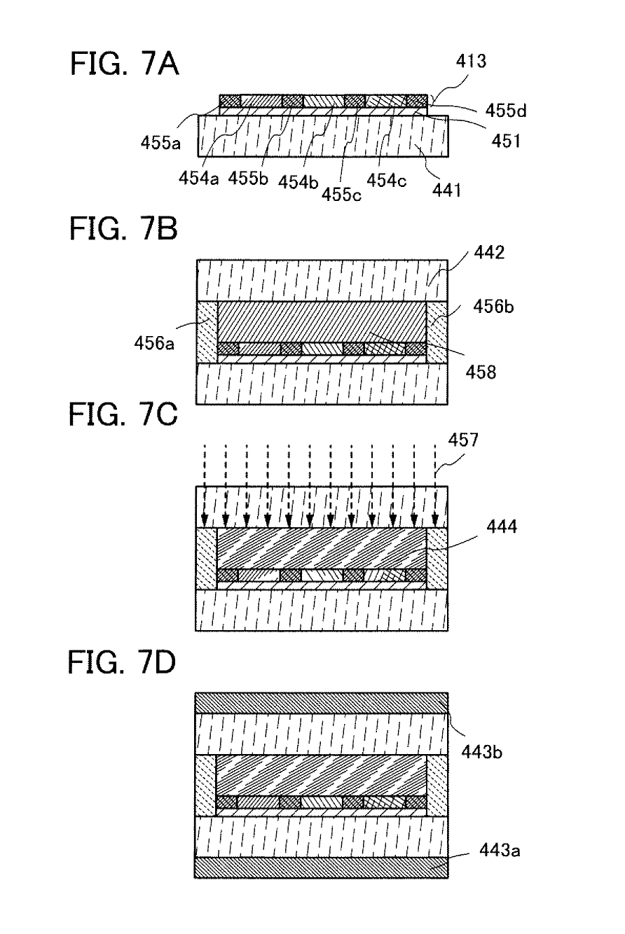

Manufacturing steps of the liquid crystal display device illustrated in FIGS. 2A and 2B is described with reference to FIGS. 7A to 7D. FIGS. 7A to 7D are cross-sectional views illustrating the manufacturing steps of the liquid crystal display device.

In FIG. 7A, an element layer 451 is formed over the first substrate 441 which is an element substrate, and the interlayer film 413 is formed over the element layer 451.

The interlayer film 413 includes light-transmitting chromatic color resin layers 454a, 454b, and 454c and light-blocking layers 455a, 455b, 455c, and 455d. The light-blocking layers 455a, 455b, 455c, and 455d and the light-transmitting chromatic color resin layers 454a, 454b, and 454c are alternately arranged such that the light-transmitting chromatic color resin layers are interposed between the light-blocking layers. Note that the pixel electrode layer and the common electrode layer are omitted in FIGS. 7A to 7D.

As illustrated in FIG. 7B, the first substrate 441 and the second substrate 442 which is a counter substrate are firmly attached to each other by sealants 456a and 456b with the liquid crystal layer 458 interposed between the substrates. The liquid crystal layer 458 can be formed by a dispenser method (a dropping method), or an injecting method by which a liquid crystal is injected using a capillary phenomenon after the first substrate 441 and the second substrate 442 are bonded to each other.

A liquid crystal material exhibiting a blue phase can be used for the liquid crystal layer 458. The liquid crystal layer 458 is formed using a liquid crystal material including a liquid crystal, a chiral agent, a photocurable resin, and a photopolymerization initiator.

As the sealants 456a and 456b, typically, a visible light curable resin, an ultraviolet curable resin, or a thermosetting resin is preferably used. Typically, an acrylic resin, an epoxy resin, an amine resin, or the like can be used. In addition, a photopolymerization initiator (typically, an ultraviolet polymerization initiator), a thermosetting agent, a filler, or a coupling agent may also be included in the sealants 456a and 456b

As illustrated in FIG. 7C, polymer stabilization treatment is performed by irradiating the liquid crystal layer 458 with light 457 to form the liquid crystal layer 444. The light 457 is light having a wavelength with which the photocurable resin and the photopolymerization initiator included in the liquid crystal layer 458 react. By this polymer stabilization treatment with light irradiation, the temperature range in which the liquid crystal layer 444 exhibits a blue phase can be widened.

In the case where a photocurable resin such as an ultraviolet curable resin is used for the sealants and the liquid crystal layer is formed by a dropping method, for example, the sealants may be cured by the light irradiation step of the polymer stabilization treatment.

As illustrated in FIGS. 7A to 7D, when the liquid crystal display device has a structure in which a color filter layer and a light-blocking layer are formed over an element substrate, light emitted from the counter substrate side is not absorbed nor blocked by the color filter layer and the light-blocking layer. Therefore, the whole liquid crystal layer can be uniformly irradiated with the light. Thus, alignment disorder of a liquid crystal due to nonuniform photopolymerization, display unevenness due to the alignment disorder of a liquid crystal, or the like can be prevented. Further, a thin film transistor can also be shielded from light by the light-blocking layer, whereby defects in electric characteristics due to the light irradiation can be prevented.

As illustrated in FIG. 7D, the polarizing plate 443a is provided on the outside (the side opposite to the liquid crystal layer 444) of the first substrate 441, and the polarizing plate 443b is provided on the outside (the side opposite to the liquid crystal layer 444) of the second substrate 442. In addition to the polarizing plates, an optical film such as a retardation plate or an anti-reflection film, or the like may be provided. For example, circular polarization using a polarizing plate and a retardation plate may be employed. Through the above-described steps, the liquid crystal display device can be completed.

In the case where a plurality of liquid crystal display devices is manufactured using a large-sized substrate (a so-called multiple panel method), a division step can be performed either before the polymer stabilization treatment or before provision of the polarizing plates. In consideration of influence of the division step (such as alignment disorder due to force applied in the division step) on the liquid crystal layer, the division step is preferably performed after the bonding between the first substrate and the second substrate and before the polymer stabilization treatment.

Although not illustrated, a backlight, a sidelight, or the like may be used as a light source. Light from the light source is emitted from the side of the first substrate 441 which is an element substrate so as to pass through the second substrate 442 on the viewing side.

The first electrode layer 447 and the second electrode layer 446 can be formed using a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added.

The first electrode layer 447 and the second electrode layer 446 can be formed using one kind or plural kinds selected from metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), or silver (Ag); an alloy thereof; and a nitride thereof.

A conductive composition containing a conductive high molecule (also referred to as a conductive polymer) can be used to form the first electrode layer 447 and the second electrode layer 446. The pixel electrode formed using the conductive composition preferably has a sheet resistance of 10000 ohms per square or less and a light transmittance of 70% or more at a wavelength of 550 nm. Furthermore, the resistivity of the conductive high molecule contained in the conductive composition is preferably 0.1 Ω·cm or less.

As the conductive high molecule, a so-called π-electron conjugated conductive high-molecule can be used. For example, polyaniline or a derivative thereof, polypyrrole or a derivative thereof, polythiophene or a derivative thereof, and a copolymer of two or more kinds of these can be given.

An insulating film serving as a base film may be provided between the first substrate 441 and the gate electrode layer 401. The base film functions to prevent diffusion of an impurity element from the first substrate 441 and can be formed using one film or stacked films selected from a silicon nitride film, a silicon oxide film, a silicon nitride oxide film, and a silicon oxynitride film. The gate electrode layer 401 can be formed to have a single-layer structure or a stacked structure using a metal material such as molybdenum, titanium, chromium, tantalum, tungsten, aluminum, copper, neodymium, or scandium or an alloy material which contains any of these materials as its main component. By using a light-blocking conductive film as the gate electrode layer 401, light from a backlight (light emitted through the first substrate 441) can be prevented from entering the semiconductor layer 403.

For example, as a two-layer structure of the gate electrode layer 401, the following structures are preferable: a two-layer structure of an aluminum layer and a molybdenum layer stacked thereover, a two-layer structure of a copper layer and a molybdenum layer stacked thereover, a two-layer structure of a copper layer and a titanium nitride layer or a tantalum nitride layer stacked thereover, and a two-layer structure of a titanium nitride layer and a molybdenum layer. As a three-layer structure, a stacked structure of a tungsten layer or a tungsten nitride layer, a layer of an alloy of aluminum and silicon or an alloy of aluminum and titanium, and a titanium nitride layer or a titanium layer is preferable.

The gate insulating layer 402 can be formed to have a single-layer structure or a stacked structure using a silicon oxide layer, a silicon nitride layer, a silicon oxynitride layer, or a silicon nitride oxide layer by a plasma CVD method, a sputtering method, or the like. Alternatively, the gate insulating layer 402 can be formed of a silicon oxide layer by a CVD method using an organosilane gas. As the organosilane gas, a silicon-containing compound such as tetraethoxysilane (TEOS: chemical formula, Si(OC₂H₅)₄), tetramethylsilane (TMS: chemical formula, Si(CH₃)₄), tetramethylcyclotetrasiloxane (TMCTS), octamethylcyclotetrasiloxane (OMCTS), hexamethyldisilazane (HMDS), triethoxy silane (SiH(OC₂H₅)₃), or trisdimethylaminosilane (SiH(N(CH₃)₂)₃) can be used.

In the manufacturing steps of the semiconductor layer, the n⁺ layers, and the wiring layers, an etching step is used to process thin films into desired shapes. Dry etching or wet etching can be employed for the etching step.

As an etching apparatus used for dry etching, an etching apparatus that uses reactive ion etching (RIE), or a dry etching apparatus that uses a high-density plasma source such as an electron cyclotron resonance (ECR) source or an inductively coupled plasma (ICP) source can be used. As a dry etching apparatus with which uniform discharge can be easily obtained over a large area as compared to an ICP etching apparatus, there is an enhanced capacitively coupled plasma (ECCP) mode etching apparatus in which an upper electrode is grounded, a high-frequency power source of 13.56 MHz is connected to a lower electrode, and further a low-frequency power source of 3.2 MHz is connected to the lower electrode. This ECCP mode etching apparatus, if used, can be applied even when a substrate having a size exceeding 3 meters of the tenth generation is used as a substrate, for example.

In order to perform etching into a desired processed shape, etching conditions (such as the amount of power applied to a coiled electrode, the amount of power applied to an electrode on the substrate side, or the temperature of the electrode on the substrate side) are adjusted as appropriate.

In order to perform etching into a desired processed shape, etching conditions (such as an etching solution, time for etching, or a temperature) are adjusted as appropriate in accordance with the material.

As a material for the wiring layers 405a and 405b, an element selected from Al, Cr, Ta, Ti, Mo, and W, an alloy containing any of the above elements, an alloy film containing any of the above elements in combination, and the like can be given. Further, in the case where heat treatment is performed, the conductive film preferably has heat resistance against the heat treatment. Since use of Al alone brings disadvantages such as low resistance and a tendency to corrosion, aluminum is used in combination with a conductive material having heat resistance. As the conductive material having heat resistance which is used in combination with Al, any of the following materials may be used: an element selected from titanium (Ti), tantalum (Ta), tungsten (W), molybdenum (Mo), chromium (Cr), neodymium (Nd), and scandium (Sc), an alloy containing any of the above elements, an alloy film containing any of the above elements in combination, and a nitride containing any of the above elements.

The gate insulating layer 402, the semiconductor layer 403, the n⁺ layers 404a and 404b, and the wiring layers 405a and 405b may be formed in succession without being exposed to the air. By successive formation without exposure to the air, each interface between the stacked layers can be formed without being contaminated by atmospheric components or contaminating impurities contained in the air; therefore, variation in characteristics of the thin film transistor can be reduced.

Note that the semiconductor layer 403 is partially etched and has a groove (a depression portion).

The insulating film 407 covering the thin film transistor 420 can be formed using an inorganic insulating film or an organic insulating film formed by a wet method or a dry method. For example, the insulating film 407 can be formed using a silicon nitride film, a silicon oxide film, a silicon oxynitride film, an aluminum oxide film, a tantalum oxide film, or the like by a CVD method, a sputtering method, or the like. Alternatively, an organic material such as polyimide, acrylic, benzocyclobutene, polyamide, or epoxy can be used. Other than such organic materials, it is also possible to use a low-dielectric constant material (a low-k material), a siloxane-based resin, PSG (phosphosilicate glass), BPSG (borophosphosilicate glass), or the like.

Note that a siloxane-based resin is a resin formed using a siloxane-based material as a starting material and having the bond of Si—O—Si. A siloxane-based resin may include, as a substituent, an organic group (e.g., an alkyl group or an aryl group) or a fluoro group. The organic group may include a fluoro group. A siloxane-based resin is applied by a coating method and baked; thus, the insulating film 407 can be formed.

Alternatively, the insulating film 407 may be formed by stacking plural insulating films formed using any of these materials. For example, the insulating film 407 may have such a structure in which an organic resin film is stacked over an inorganic insulating film.

Further, by using a resist mask which is formed using a multi-tone mask and has regions with plural thicknesses (typically, two different thicknesses), the number of resist masks can be reduced, resulting in simplified process and lower cost.

In the above-described manner, in the liquid crystal display device using the liquid crystal layer exhibiting a blue phase, contrast ratio can be increased.

### Embodiment 3

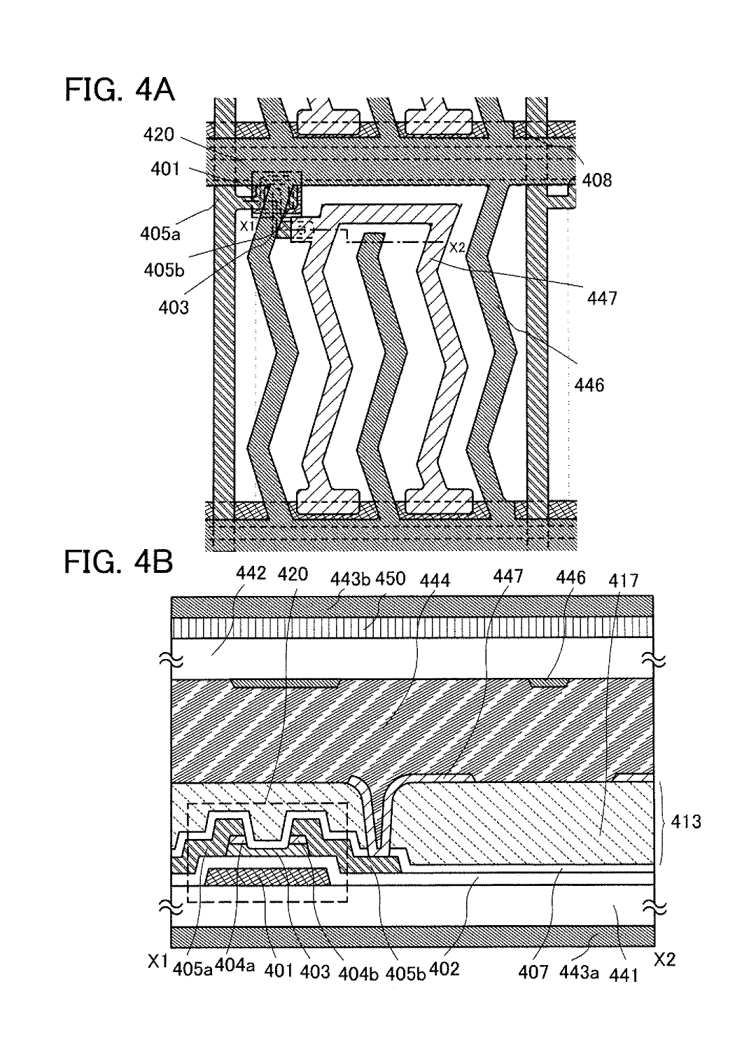

FIGS. 4A and 4B illustrate an example in which a color filter is provided outside substrates between which a liquid crystal layer is interposed in Embodiment 2. Note that components in common with those in Embodiment 1 and Embodiment 2 can be formed using a similar material and manufacturing method, and detailed description of the same portions and portions having similar functions will be omitted.

FIG. 4A is a plan view of a liquid crystal display device and illustrates one pixel. FIG. 4B is a cross-sectional view taken along line X1-X2 in FIG. 4A.

In the plan view of FIG. 4A, a plurality of source wiring layers (including the wiring layer 405a) is arranged so as to be parallel to (extend in a vertical direction in the drawing) and apart from each other, in a manner similar to Embodiment 2. A plurality of gate wiring layers (including the gate electrode layer 401) is arranged so as to extend in a direction generally perpendicular to the source wiring layers (in a horizontal direction in the drawing) and be apart from each other. The capacitor wiring layers 408 are arranged adjacent to the plurality of gate wiring layers and extend in a direction generally parallel to the gate wiring layers, that is, in a direction generally perpendicular to the source wiring layers (in the horizontal direction in the drawing). A roughly rectangular space is surrounded by the source wiring layers, the capacitor wiring layer 408, and the gate wiring layers. In this space, a pixel electrode layer and a common electrode layer of the liquid crystal display device are arranged with the liquid crystal layer 444 interposed therebetween. The thin film transistor 420 for driving the pixel electrode layer is arranged on an upper left corner in the drawing. A plurality of pixel electrode layers and thin film transistors are arranged in matrix.

In the liquid crystal display device in FIGS. 4A and 4B, a color filter 450 is provided between the second substrate 442 and the polarizing plate 443b. The color filter 450 may be thus provided on the outside of the first substrate 441 and the second substrate 442 between which the liquid crystal layer 444 is interposed.

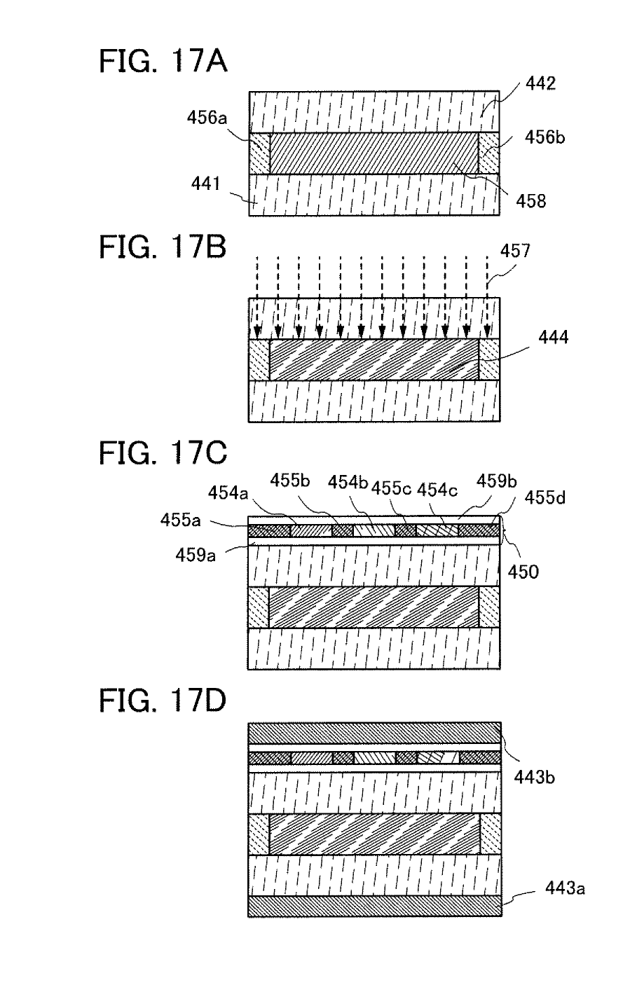

Manufacturing steps of the liquid crystal display device in FIGS. 4A and 4B are illustrated in FIGS. 17A to 17D.

Note that the pixel electrode layer and the common electrode layer are omitted in FIGS. 17A to 17D. For example, the structures of Embodiment 1 and Embodiment 2 can be employed for the pixel electrode layer and the common electrode layer, and an oblique electric field mode can be applied.

As illustrated in FIG. 17A, the first substrate 441 and the second substrate 442 which is a counter substrate are firmly attached to each other by the sealants 456a and 456b with the liquid crystal layer 458 interposed between the substrates. The liquid crystal layer 458 can be formed by a dispenser method (a dropping method), or an injecting method by which a liquid crystal is injected using a capillary phenomenon after bonding the first substrate 441 and the second substrate 442 to each other.

A liquid crystal material exhibiting a blue phase is used for the liquid crystal layer 458. The liquid crystal layer 458 is formed using a liquid crystal material including a liquid crystal, a chiral agent, a photocurable resin, and a photopolymerization initiator.

As illustrated in FIG. 17B, polymer stabilization treatment is performed by irradiating the liquid crystal layer 458 with the light 457 to form the liquid crystal layer 444. The light 457 is light having a wavelength with which the photocurable resin and the photopolymerization initiator included in the liquid crystal layer 458 react. By this polymer stabilization treatment with light irradiation, the temperature range in which the liquid crystal layer 458 exhibits a blue phase can be widened.

In the case where a photocurable resin such as an ultraviolet curable resin is used for the sealants and the liquid crystal layer is formed by a dropping method, for example, the sealants may be cured by the light irradiation step of the polymer stabilization treatment.

Next, as illustrated in FIG. 17C, the color filter 450 is provided on the second substrate 442 side which is the viewing side. The color filter 450 includes the light-transmitting chromatic color resin layers 454a, 454b, and 454c functioning as color filter layers, and the light-blocking layers 455a, 455b, 455c, and 455d functioning as black matrix layers between a pair of substrates 459a and 459b. The light-blocking layers 455a, 455b, 455c, and 455d and the light-transmitting chromatic color resin layers 454a, 454b, and 454c are arranged alternately such that the light-transmitting chromatic color resin layers are interposed between the light-blocking layers.

As illustrated in FIG. 17D, the polarizing plate 443a is provided on the outside (a side opposite to the liquid crystal layer 444) of the first substrate 441, and the polarizing plate 443b is provided on the outside (a side opposite to the liquid crystal layer 444) of the color filter 450. In addition to the polarizing plates, an optical film such as a retardation plate or an anti-reflection film, or the like may be provided. For example, circular polarization using a polarizing plate and a retardation plate may be employed. Through the above-described steps, the liquid crystal display device can be completed.

In the case where a plurality of liquid crystal display devices are manufactured with the use of a large-sized substrate (a so-called multiple panel method), a division step can be performed either before the polymer stabilization treatment or before provision of the polarizing plates. In consideration of influence of the division step (such as alignment disorder due to force applied in the division step) on the liquid crystal layer, the division step is preferably performed after the bonding between the first substrate and the second substrate and before the polymer stabilization treatment.

Although not illustrated, a backlight, a sidelight, or the like may be used as a light source. Light from the light source is emitted from the side of the first substrate 441 which is an element substrate so as to pass through the second substrate 442 on the viewing side.

In the above-described manner, in the liquid crystal display device using the liquid crystal layer exhibiting a blue phase, contrast ratio can be increased.

### Embodiment 4

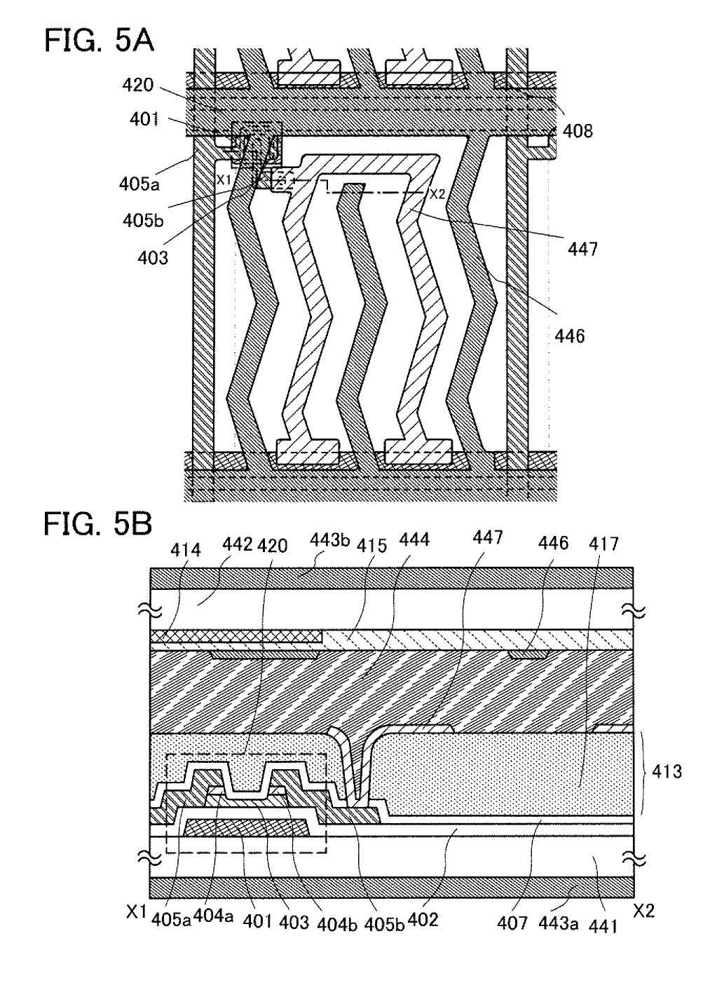

A liquid crystal display device including a light-blocking layer (a black matrix) will be described with reference to FIGS. 5A and 5B.

The liquid crystal display device illustrated in FIGS. 5A and 5B is an example in which a light-blocking layer 414 is further formed on the side of the second substrate 442 which is a counter substrate in the liquid crystal display device illustrated in FIGS. 2A and 2B of Embodiment 2. Therefore, components in common with those in Embodiment 2 can be formed using a similar material and manufacturing method, and detailed description of the same portions and portions having similar functions will be omitted.

FIG. 5A is a plan view of the liquid crystal display device, and FIG. 5B is a cross-sectional view taken along line X1-X2 in FIG. 5A. Note that the plan view of FIG. 5A illustrates only the element substrate side and the counter substrate side is not illustrated.

The light-blocking layer 414 is formed on the liquid crystal layer 444 side of the second substrate 442, and an insulating layer 415 is formed as a planarizing film. The light-blocking layer 414 is preferably formed in a region corresponding to the thin film transistor 420 (a region overlapping with a semiconductor layer of the thin film transistor) with the liquid crystal layer 444 interposed therebetween. The first substrate 441 and the second substrate 442 are firmly attached to each other with the liquid crystal layer 444 interposed therebetween so that the light-blocking layer 414 is arranged to cover at least the semiconductor layer 403 of the thin film transistor 420.

For the light-blocking layer 414, a light-blocking material which reflects or absorbs light is used. For example, a black organic resin can be used, which may be formed by mixing a black resin of a pigment material, carbon black, titanium black, or the like into a resin material such as photosensitive or nonphotosensitive polyimide. Alternatively, a light-blocking metal film can be used; for example, chromium, molybdenum, nickel, titanium, cobalt, copper, tungsten, aluminum, or the like may be used.

There is no particular limitation on the method for forming the light-blocking layer 414, and the following method may be employed in accordance with the material: a dry method such as an evaporation method, a sputtering method, or a CVD method; or a wet method such as spin coating, dip coating, spray coating, or droplet discharging (such as ink jetting, screen printing, or offset printing). If needed, etching (dry etching or wet etching) is performed to form a desired pattern.

The insulating layer 415 may also be fanned using an organic resin or the like such as acrylic or polyimide by a coating method such as spin coating or various printing methods.

When the light-blocking layer 414 is further provided on the counter substrate side in this manner, contrast can be further improved and the thin film transistor can be further stabilized. The light-blocking layer 414 can block incident light on the semiconductor layer 403 of the thin film transistor 420; accordingly, electric characteristics of the thin film transistor 420 can be prevented from being varied due to photosensitivity of the semiconductor and can be further stabilized. Further, the light-blocking layer 414 can prevent light leakage to an adjacent pixel, which enables higher contrast and higher definition display. Therefore, higher definition and higher reliability of the liquid crystal display device can be achieved.

An electric field is applied between the pixel electrode layer and the common electrode layer which have opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In the above-described manner, in the liquid crystal display device using the liquid crystal layer exhibiting a blue phase, contrast ratio can be increased.

This embodiment can be implemented in combination with any of the structures described in the other embodiments as appropriate.

### Embodiment 5

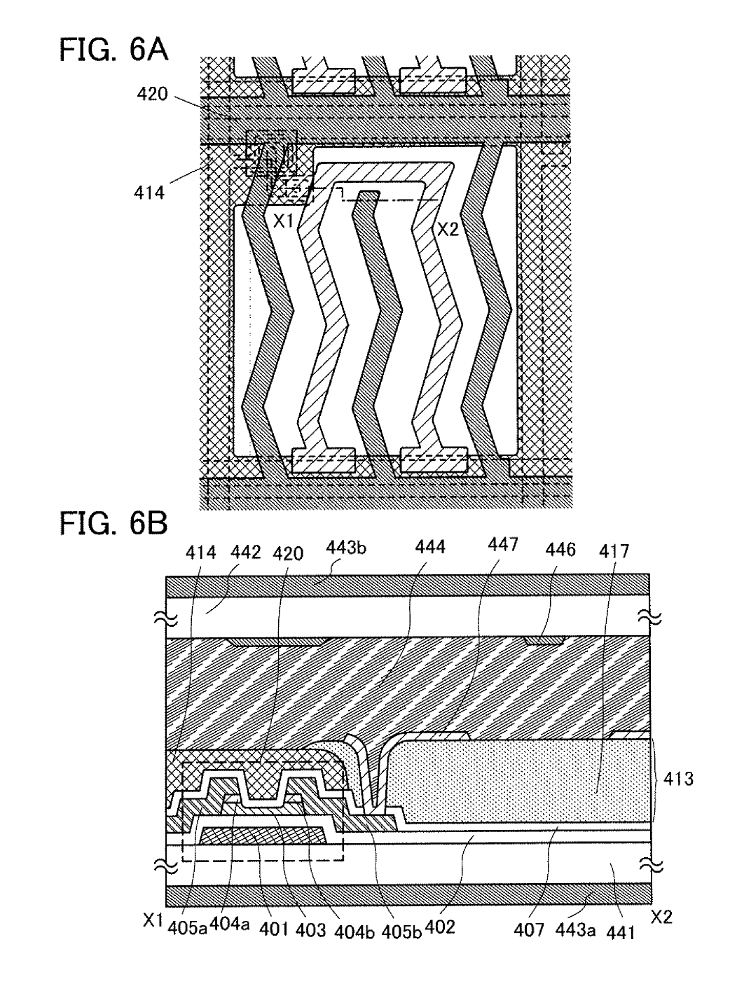

A liquid crystal display device including a light-blocking layer (a black matrix) will be described with reference to FIGS. 6A and 6B.

The liquid crystal display device illustrated in FIGS. 6A and 6B is an example in which the light-blocking layer 414 is formed as part of the interlayer film 413 on the side of the first substrate 441 which is an element substrate in the liquid crystal display device illustrated in FIGS. 2A and 2B of Embodiment 2. Therefore, components in common with those in Embodiment 2 can be formed using a similar material and manufacturing method, and detailed description of the same portions and portions having similar functions will be omitted.

FIG. 6A is a plan view of the liquid crystal display device, and FIG. 6B is a cross-sectional view taken along line X1-X2 in FIG. 6A. Note that the plan view of FIG. 6A illustrates only the element substrate side and the counter substrate side is not illustrated.

The interlayer film 413 includes the light-blocking layer 414 and the light-transmitting chromatic color resin layer 417. The light-blocking layer 414 is provided on the side of the first substrate 441 which is an element substrate. The light-blocking layer 414 is formed over the thin film transistor 420 (at least in a region which covers a semiconductor layer of the thin film transistor) with the insulating film 407 interposed therebetween, and functions as a light-blocking layer for the semiconductor layer. On the contrary, the light-transmitting chromatic color resin layer 417 is formed so as to overlap with the first electrode layer 447 and the second electrode layer 446, and functions as a color filter layer. In the liquid crystal display device of FIG. 6A, part of the second electrode layer 446 is formed over the light-blocking layer 414, and the liquid crystal layer 444 is formed over the part of the second electrode layer 446.

Since the light-blocking layer 414 is used as an interlayer film, it is preferably formed using a black organic resin. For example, a black resin of a pigment material, carbon black, titanium black, or the like may be mixed into a resin material such as photosensitive or non-photosensitive polyimide. As the formation method of the light-blocking layer 414, any of the following wet methods may be used in accordance with the material: spin coating, dip coating, spray coating, and droplet discharging (such as ink jetting, screen printing, or offset printing). If needed, etching (dry etching or wet etching) may be performed to form a desired pattern.

The light-blocking layer 414 is thus provided, whereby the light-blocking layer 414 can block incident light on the semiconductor layer 403 of the thin film transistor 420 without reduction in aperture ratio of a pixel, so that electric characteristics of the thin film transistor 420 can be prevented from being varied and can be stabilized. Further, the light-blocking layer 414 can prevent light leakage to an adjacent pixel, which enables higher contrast and higher definition display. Accordingly, higher definition and higher reliability of the liquid crystal display device can be achieved.

In addition, the light-transmitting chromatic color resin layer 417 can function as a color filter layer. In the case where a color filter layer is provided on the counter substrate side, it is difficult to precisely align a pixel region with the element substrate over which the thin film transistor is formed and thus there is a possibility that image quality is degraded. Here, since the light-transmitting chromatic color resin layer 417 included in the interlayer film is formed as the color filter layer directly on the element substrate side, the formation region can be controlled more precisely and this structure is adjustable to a pixel with a fine pattern. In addition, one insulating layer can serve as both the interlayer film and the color filter layer, whereby the process can be simplified and a liquid crystal display device can be manufactured at lower cost.

An electric field is applied between the pixel electrode layer and the common electrode layer which have opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In the above-described manner, in the liquid crystal display device using the liquid crystal layer exhibiting a blue phase, contrast ratio can be increased.

This embodiment can be implemented in combination with any of the structures described in the other embodiments as appropriate.

### Embodiment 6

Another example of a thin film transistor which can be applied to the liquid crystal display devices of Embodiments 1 to 5 will be described. Note that components in common with those in Embodiments 2 to 5 can be formed using a similar material and manufacturing method, and detailed description of the same portions and portions having similar functions will be omitted.

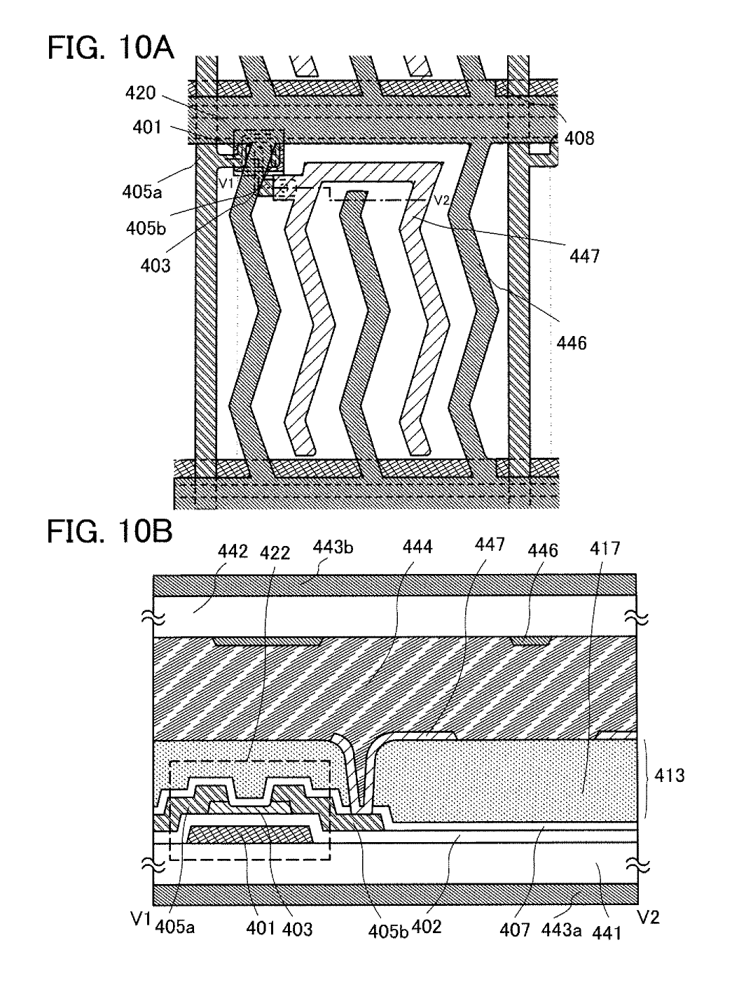

FIGS. 10A and 10B illustrate an example of a liquid crystal display device including a thin film transistor having a structure in which a source electrode layer and a drain electrode layer are in contact with a semiconductor layer without an n⁺ layer interposed therebetween.

FIG. 10A is a plan view of the liquid crystal display device and illustrates one pixel. FIG. 10B is a cross-sectional view taken along line V1-V2 in FIG. 10A.

In the plan view of FIG. 10A, a plurality of source wiring layers (including the wiring layer 405a) is arranged so as to be parallel to (extend in a vertical direction in the drawing) and apart from each other, in a similar manner to Embodiment 2. A plurality of gate wiring layers (including the gate electrode layer 401) is arranged so as to extend in a direction generally perpendicular to the source wiring layers (in a horizontal direction in the drawing) and be apart from each other. The capacitor wiring layers 408 are arranged adjacent to the plurality of gate wiring layers and extend in a direction generally parallel to the gate wiring layers, that is, in a direction generally perpendicular to the source wiring layers (in the horizontal direction in the drawing). A roughly rectangular space is surrounded by the source wiring layers, the capacitor wiring layer 408, and the gate wiring layers. In this space, a pixel electrode layer and a common electrode layer of the liquid crystal display device are arranged. A thin film transistor 422 for driving the pixel electrode layer is arranged on an upper left corner in the drawing. A plurality of pixel electrode layers and thin film transistors are arranged in matrix.

The first substrate 441 provided with the thin film transistor 422, the interlayer film 413 which is a light-transmitting chromatic color resin layer, and the first electrode layer 447 and the second substrate 442 provided with the second electrode layer 446 are firmly attached to each other with the liquid crystal layer 444 interposed between the substrates.

The thin film transistor 422 has a structure in which the wiring layers 405a and 405b that function as a source electrode layer and a drain electrode layer are in contact with the semiconductor layer 403 without an n⁺ layer interposed therebetween.

The pixel electrode layer formed over the first substrate and the common electrode layer formed on the second substrate are firmly attached to each other by a sealant with the liquid crystal layer interposed between the electrode layers. The pixel electrode layer and the common electrode layer do not have flat shapes but have various opening patterns, and each have a shape including a bending portion or a branching-comb shape.

An electric field is applied between the pixel electrode layer and the common electrode layer which have the opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In the above-described manner, in the liquid crystal display device using the liquid crystal layer exhibiting a blue phase, contrast ratio can be increased.

This embodiment can be implemented in combination with any of the structures described in the other embodiments as appropriate.

### Embodiment 7

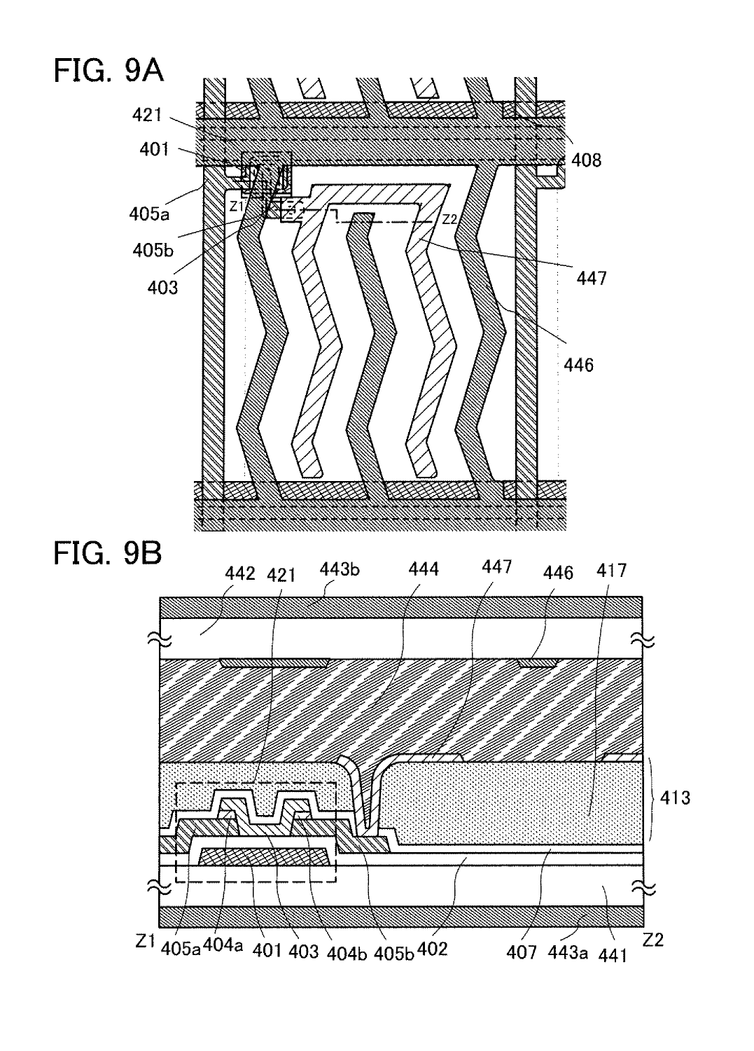

Another example of a thin film transistor which can be applied to the liquid crystal display devices of Embodiments 1 to 5 will be described with reference to FIGS. 9A and 9B.

FIG. 9A is a plan view of a liquid crystal display device and illustrates one pixel. FIG. 9B is a cross-sectional view taken along line Z1-Z2 in FIG. 9A.

In the plan view of FIG. 9A, a plurality of source wiring layers (including the wiring layer 405a) is arranged so as to be parallel to (extend in a vertical direction in the drawing) and apart from each other, in a similar manner to Embodiment 2. A plurality of gate wiring layers (including the gate electrode layer 401) is arranged so as to extend in a direction generally perpendicular to the source wiring layers (in a horizontal direction in the drawing) and be apart from each other. The capacitor wiring layers 408 are arranged adjacent to the plurality of gate wiring layers and extend in a direction generally parallel to the gate wiring layers, that is, in a direction generally perpendicular to the source wiring layers (in the horizontal direction in the drawing). A roughly rectangular space is surrounded by the source wiring layers, the capacitor wiring layer 408, and the gate wiring layers. In this space, a pixel electrode layer and a common electrode layer of the liquid crystal display device are arranged. A thin film transistor 421 for driving the pixel electrode layer is arranged on an upper left corner in the drawing. A plurality of pixel electrode layers and thin film transistors are arranged in matrix.

The first substrate 441 provided with the thin film transistor 421, the interlayer film 413 which is a light-transmitting chromatic color resin layer, and the first electrode layer 447 and the second substrate 442 provided with the second electrode layer 446 are firmly attached to each other with the liquid crystal layer 444 interposed between the substrates.

The thin film transistor 421 is a bottom-gate thin film transistor and includes, over the first substrate 441 which is a substrate having an insulating surface, the gate electrode layer 401, the gate insulating layer 402, the wiring layers 405a and 405b functioning as a source electrode layer and a drain electrode layer, the n⁺ layers 404a and 404b functioning as a source region and a drain region, and the semiconductor layer 403. Further, the insulating film 407 which is in contact with the semiconductor layer 403 is provided so as to cover the thin film transistor 421.

Note that the n⁺ layers 404a and 404b may be provided between the gate insulating layer 402, and the wiring layers 405a and 405b. Alternatively, n⁺ layers may be provided both between the gate insulating layer and the wiring layers and between the wiring layers and the semiconductor layer.

In the thin film transistor 421, the gate insulating layer 402 exists in an entire region including the thin film transistor 421 and the gate electrode layer 401 is provided between the gate insulating layer 402 and the first substrate 441 which is a substrate having an insulating surface. The wiring layers 405a and 405b and the n⁺ layers 404a and 404b are provided over the gate insulating layer 402. The semiconductor layer 403 is provided over the gate insulating layer 402, the wiring layers 405a and 405b, and the n⁺ layers 404a and 404b. Although not illustrated, a wiring layer is provided over the gate insulating layer 402 in addition to the wiring layers 405a and 405b and the wiring layer extends beyond the perimeter of the semiconductor layer 403 to the outside.

An electric field is applied between the pixel electrode layer and the common electrode layer which have opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In the above-described manner, in the liquid crystal display device using the liquid crystal layer exhibiting a blue phase, contrast ratio can be increased.

This embodiment can be implemented in combination with any of the structures described in the other embodiments as appropriate.

### Embodiment 8

Another example of a thin film transistor which can be applied to the liquid crystal display devices of Embodiments 2 to 5 will be described. Note that components in common with those in Embodiments 2 to 5 can be formed using a similar material and manufacturing method, and detailed description of the same portions and portions having similar functions will be omitted.

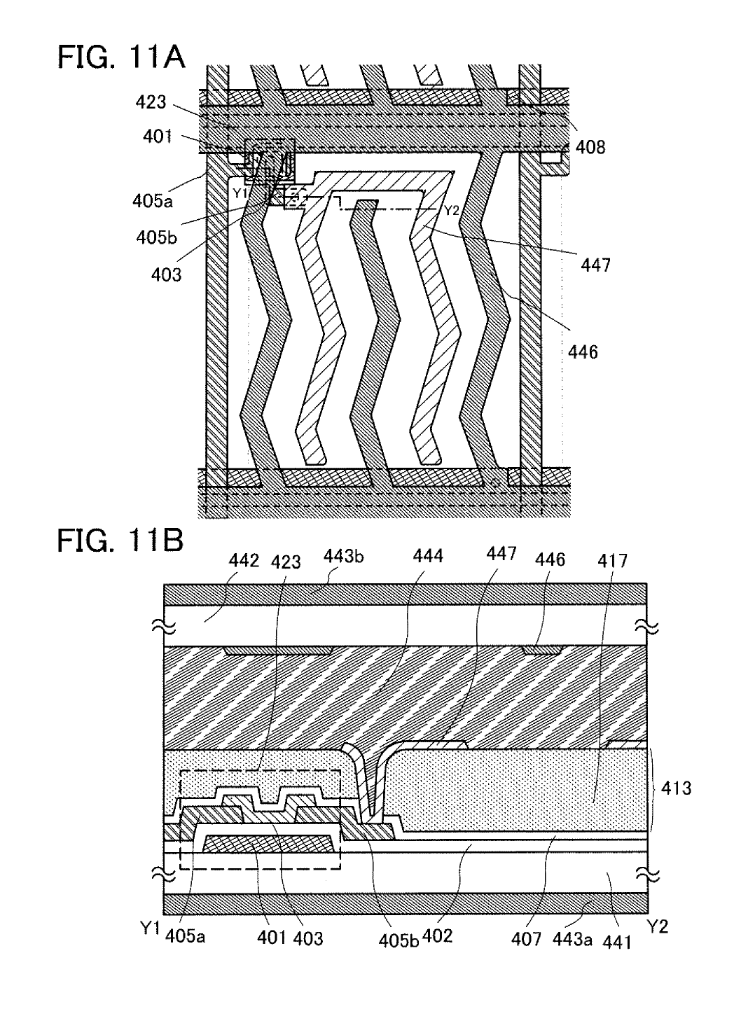

FIGS. 11A and 11B illustrate an example of a liquid crystal display device including a thin film transistor having a structure in which a source electrode layer and a drain electrode layer are in contact with a semiconductor layer without an n⁺ layer interposed therebetween.

FIG. 11A is a plan view of the liquid crystal display device and illustrates one pixel. FIG. 11B is a cross-sectional view taken along line Yl-Y2 in FIG. 11A.

In the plan view of FIG. 11A, a plurality of source wiring layers (including the wiring layer 405a) is arranged so as to be parallel to (extend in a vertical direction in the drawing) and apart from each other, in a similar manner to Embodiment 2. A plurality of gate wiring layers (including the gate electrode layer 401) is arranged so as to extend in a direction generally perpendicular to the source wiring layers (in a horizontal direction in the drawing) and be apart from each other. The capacitor wiring layers 408 are arranged adjacent to the plurality of gate wiring layers and extend in a direction generally parallel to the gate wiring layers, that is, in a direction generally perpendicular to the source wiring layers (in the horizontal direction in the drawing). A roughly rectangular space is surrounded by the source wiring layers, the capacitor wiring layer 408, and the gate wiring layers. In this space, a pixel electrode layer and a common electrode layer of the liquid crystal display device are arranged. A thin film transistor 423 for driving the pixel electrode layer is arranged on an upper left corner in the drawing. A plurality of pixel electrode layers and thin film transistors are arranged in matrix.

The first substrate 441 provided with the thin film transistor 423, the interlayer film 413 which is a light-transmitting chromatic color resin layer, and the first electrode layer 447 and the second substrate 442 provided with the second electrode layer 446 are firmly attached to each other with the liquid crystal layer 444 interposed between the substrates.

In the thin film transistor 423, the gate insulating layer 402 exists in an entire region including the thin film transistor 423 and the gate electrode layer 401 is provided between the gate insulating layer 402 and the first substrate 441 which is a substrate having an insulating surface. The wiring layers 405a and 405b are provided over the gate insulating layer 402. The semiconductor layer 403 is provided over the gate insulating layer 402 and the wiring layers 405a and 405b. Although not illustrated, a wiring layer is provided over the gate insulating layer 402 in addition to the wiring layers 405a and 405b and the wiring layer extends beyond the perimeter of the semiconductor layer 403 to the outside.

An electric field is applied between the pixel electrode layer and the common electrode layer which have opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

In the above-described manner, in the liquid crystal display device using the liquid crystal layer exhibiting a blue phase, contrast ratio can be increased.

This embodiment can be implemented in combination with any of the structures described in the other embodiments as appropriate.

### Embodiment 9

An example of a material which can be used for any of the semiconductor layers of the thin film transistors of Embodiments 1 to 8 will be described. There is no particular limitation on the semiconductor material used for the semiconductor layer of the thin film transistor included in the liquid crystal display device disclosed in this specification.

A semiconductor layer included in a semiconductor element can be formed using any of the following materials: an amorphous semiconductor (hereinafter also referred to as an “AS”) formed by a vapor deposition method using a semiconductor material gas typified by silane or germane or by a sputtering method; a polycrystalline semiconductor formed by crystallizing the amorphous semiconductor by utilizing light energy or thermal energy; a microcrystalline (also referred to as semiamorphous or microcrystalline) semiconductor (hereinafter also referred to as a “SAS”); and the like. The semiconductor layer can be formed by a sputtering method, an LPCVD method, a plasma CVD method, or the like.

A microcrystalline semiconductor film belongs to a metastable state which is an intermediate between amorphous and single crystal when Gibbs free energy is considered. In other words, the microcrystalline semiconductor film is a semiconductor having a third state which is stable in terms of free energy and has a short-range order and lattice distortion. Columnar-like or needle-like crystals grow in a normal direction with respect to a substrate surface. The Raman spectrum of microcrystalline silicon, which is a typical example of a microcrystalline semiconductor, shifts to the lower wavenumber side than 520 cm⁻¹ which represents single crystal silicon. That is, the peak of the Raman spectrum of the microcrystalline silicon exists between 520 cm⁻¹ which represents single crystal silicon and 480 cm⁻¹ which represents amorphous silicon. The semiconductor includes hydrogen or halogen of at least 1 at. % or more to terminate a dangling bond. Moreover, a rare gas element such as helium, argon, krypton, or neon may be included to further promote lattice distortion, so that stability is enhanced and a favorable microcrystalline semiconductor film can be obtained.

This microcrystalline semiconductor film can be formed by a high-frequency plasma CVD method with a frequency of several tens of MHz to several hundreds of MHz or a microwave plasma CVD apparatus with a frequency of 1 GHz or more. The microcrystalline semiconductor film can be typically formed using a dilution of silicon hydride such as SiH₄, Si₂H₆, SiH₂Cl₂, SiHCl₃, SiCl₄, or SiF₄ with hydrogen. With a dilution with one kind or plural kinds of rare gas elements selected from helium, argon, krypton, and neon in addition to silicon hydride and hydrogen, the microcrystalline semiconductor film can be formed. In that case, the flow rate ratio of hydrogen to silicon hydride is set to be 5:1 to 200:1, preferably, 50:1 to 150;1, more preferably, 100:1.

As a typical amorphous semiconductor, hydrogenated amorphous silicon can be given. As a typical crystalline semiconductor, polysilicon and the like can be given. Polysilicon (polycrystalline silicon) includes so-called high-temperature polysilicon that uses polysilicon as a main material and is formed at a process temperature higher than or equal to 800° C., so-called low-temperature polysilicon that uses polysilicon as a main material and is formed at a process temperature lower than or equal to 600° C., polysilicon obtained by crystallizing amorphous silicon by using an element that promotes crystallization or the like, and the like. Needless to say, as described above, a microcrystalline semiconductor or a semiconductor which includes a crystal phase in part of the semiconductor layer can also be used.

As a material of the semiconductor, as well as an element such as silicon (Si) or germanium (Ge), a compound semiconductor such as GaAs, InP, SiC, ZnSe, GaN, or SiGe can be used.

In the case of using a crystalline semiconductor film for the semiconductor layer, the crystalline semiconductor film may be formed by various methods (such as a laser crystallization method, a thermal crystallization method, or a thermal crystallization method using an element such as nickel which promotes crystallization). Alternatively, a microcrystalline semiconductor which is a SAS can be crystallized by laser irradiation to improve the crystallinity. When the element that promotes crystallization is not introduced, before irradiating an amorphous silicon film with laser light, the amorphous silicon film is heated at 500° C. for one hour under a nitrogen atmosphere to release hydrogen contained therein so that the concentration of hydrogen is 1×10²⁰ atoms/cm³ or less. This is because the amorphous silicon film containing a large amount of hydrogen is destroyed when being irradiated with laser light.

There is no particular limitation on the method for introducing a metal element into the amorphous semiconductor layer as long as the method is capable of making the metal element exist on the surface of or inside the amorphous semiconductor film. For example, a sputtering method, a CVD method, a plasma treatment method (including a plasma CVD method), an adsorption method, or a method of applying a solution of metal salt can be employed. Among these methods, the method using a solution is convenient and has an advantage in that the concentration of the metal element can be easily controlled. At this time, it is desirable to form an oxide film by UV light irradiation in an oxygen atmosphere, a thermal oxidation method, treatment with ozone water containing hydroxyl radical or hydrogen peroxide, or the like in order to improve wettability of the surface of the amorphous semiconductor film so that an aqueous solution is spread over the entire surface of the amorphous semiconductor film.

In a crystallization step in which an amorphous semiconductor film is crystallized to form a crystalline semiconductor film, an element which promotes crystallization (also referred to as a catalytic element or a metal element) may be added to the amorphous semiconductor film, and crystallization may be performed by heat treatment (at 550° C. to 750° C. for 3 minutes to 24 hours). As the element which promotes (accelerates) crystallization, one kind or plural kinds selected from iron (Fe), nickel (Ni), cobalt (Co), ruthenium (Ru), rhodium (Rh), palladium (Pd), osmium (Os), iridium (Ir), platinum (Pt), copper (Cu), and gold (Au) can be used.

In order to remove or reduce the element which promotes crystallization from the crystalline semiconductor film, a semiconductor film containing an impurity element is formed in contact with the crystalline semiconductor film so as to function as a gettering sink. The impurity element may be an impurity element imparting n-type conductivity, an impurity element imparting p-type conductivity, a rare gas element, or the like. For example, one kind or plural kinds of elements selected from phosphorus (P), nitrogen (N), arsenic (As), antimony (Sb), bismuth (Bi), boron (B), helium (He), neon (Ne), argon (Ar), krypton (Kr), and xenon (Xe) can be used. A semiconductor film containing a rare gas element is formed over the crystalline semiconductor film containing the element which promotes crystallization, and heat treatment (at 550° C. to 750° C. for 3 minutes to 24 hours) is performed. The element which promotes crystallization contained in the crystalline semiconductor film moves into the semiconductor film containing a rare gas element, and thus the element which promotes crystallization contained in the crystalline semiconductor film is removed or reduced. After that, the semiconductor film containing a rare gas element that has served as a gettering sink is removed.

An amorphous semiconductor film may be crystallized by a combination of heat treatment and laser light irradiation, or one of heat treatment and laser light irradiation may be performed a plurality of times.

Further, the crystalline semiconductor film may be directly formed over the substrate by a plasma method. Alternatively, the crystalline semiconductor film may be selectively formed over the substrate by the plasma method.

An oxide semiconductor may be used for the semiconductor layer. For example, zinc oxide (ZnO), tin oxide (SnO₂), or the like can be used. In the case of using ZnO for the semiconductor layer, Y₂O₃, Al₂O₃, TiO₂, a stacked layer thereof, or the like can be used for a gate insulating layer, and ITO, Au, Ti, or the like can be used for a gate electrode layer, a source electrode layer, and a drain electrode layer. In addition, In, Ga, or the like can be added to ZnO.

As the oxide semiconductor, a thin film expressed by InMO₃(ZnO)ₘ(m>0) can be used. Note that M denotes one or more of metal elements selected from gallium (Ga), iron (Fe), nickel (Ni), manganese (Mn), and cobalt (Co). In addition to a case where only Ga is contained as M, there is a case where Ga and the above metal elements other than Ga, for example, Ga and Ni or Ga and Fe are contained as M. Moreover, in the above oxide semiconductor, a transition metal element such as Fe or Ni or an oxide of the transition metal is contained as an impurity element in addition to a metal element contained as M in some cases. As the oxide semiconductor layer, for example, an In—Ga—Zn—O-based non-single-crystal film can be used.

As the oxide semiconductor layer (the InMO₃(ZnO)ₘ(m>0) film), an InMO₃(ZnO)ₘ(m>0) film in which M is another metal element may be used instead of the In—Ga—Zn—O-based non-single-crystal film.

When a blue-phase liquid crystal material is used, rubbing treatment on an alignment film is unnecessary; accordingly, electrostatic discharge damage caused by the rubbing treatment can be prevented and defects and damage of the liquid crystal display device in the manufacturing process can be reduced. Thus, productivity of the liquid crystal display device can be increased. A thin film transistor that uses an oxide semiconductor layer particularly has a possibility that electric characteristics of the thin film transistor may fluctuate significantly by the influence of static electricity and deviate from the designed range. Therefore, it is more effective to use a blue-phase liquid crystal material for a liquid crystal display device including a thin film transistor that uses an oxide semiconductor layer.

This embodiment can be implemented in combination with any of the structures described in the other embodiments as appropriate.

### Embodiment 10

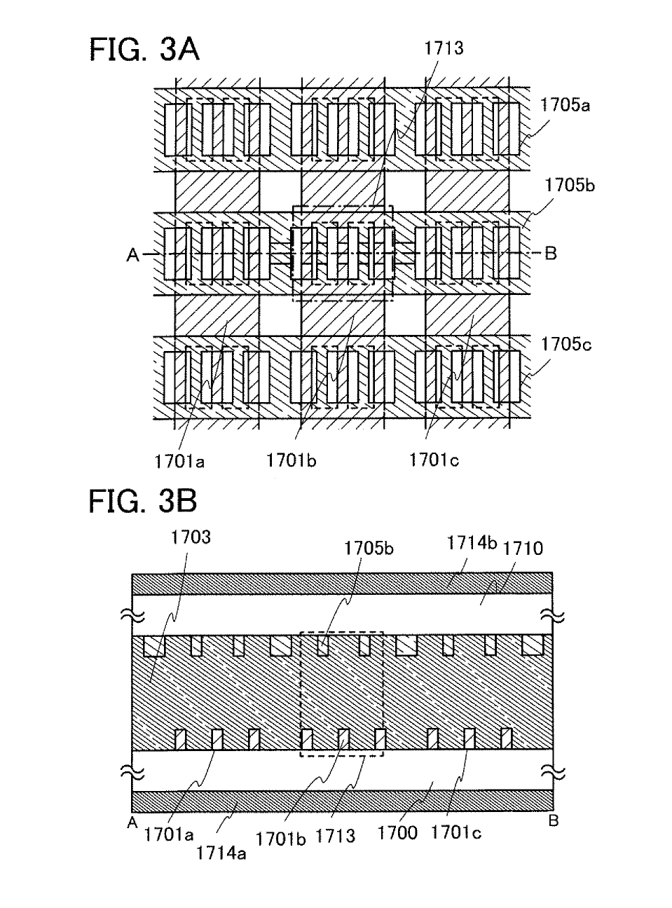

The invention disclosed in this specification can be applied to both a passive matrix liquid crystal display device and an active matrix liquid crystal display device. An example of a passive matrix liquid crystal display device will be described with reference to FIGS. 3A and 3B. FIG. 3A is a top view of the liquid crystal display device, and FIG. 3B is a cross-sectional view taken along line A-B in FIG. 3A. Although omitted and not illustrated in FIG. 3A, a liquid crystal layer 1703, a substrate 1710 serving as a counter substrate, a polarizing plate 1714a, a polarizing plate 1714b, and the like are provided as illustrated in FIG. 3B.

In FIGS. 3A and 3B, a substrate 1700 provided with pixel electrode layers 1701a, 1701b, and 1701c that extend in a first direction faces the substrate 1710 provided with common electrode layers 1705a, 1705b, and 1705c that extend in a second direction which is perpendicular to the first direction, and the polarizing plate 1714b with the liquid crystal layer 1703 exhibiting a blue phase interposed between the substrates (see FIGS. 3A and 3B).

The pixel electrode layers 1701a, 1701b, and 1701c and the common electrode layers 1705a, 1705b, and 1705c have shapes with opening patterns, and have rectangular openings (slits) in a pixel region of a liquid crystal element 1713.

An electric field is applied between the pixel electrode layers 1701a, 1701b, and 1701c and the common electrode layers 1705a, 1705b, and 1705c which have the opening patterns and are provided so that a liquid crystal is interposed therebetween, whereby an oblique (oblique to the substrates) electric field is applied to the liquid crystal. Thus, liquid crystal molecules can be controlled by the electric field. When the oblique electric field is applied to the liquid crystal layer 1703, the liquid crystal molecules in the whole liquid crystal layer including the liquid crystal molecules in the thickness direction can be made to respond, so that white transmittance is improved. Accordingly, contrast ratio, which is a ratio of white transmittance to black transmittance (light transmittance in black display), can also be increased.

A coloring layer functioning as a color filter may be provided. The color filter may be provided on the liquid crystal layer 1703 side of the substrate 1700 and the substrate 1710; alternatively, the color filter may be provided between the substrate 1710 and the polarizing plate 1714b or between the substrate 1700 and the polarizing plate 1714a.

When full-color display is performed in the liquid crystal display device, the color filter may be formed using materials exhibiting red (R), green (G), and blue (B). When monochrome display is performed, the coloring layer may be omitted or formed using a material exhibiting at least one color. Note that the color filter is not always provided in the case where light-emitting diodes (LEDs) of RGB or the like are arranged in a backlight unit and a successive additive color mixing method (a field sequential method) in which color display is performed by time division is employed.

The pixel electrode layers 1701a, 1701b, and 1701c and the common electrode layers 1705a, 1705b and 1705c can be formed using one kind or plural kinds selected from indium tin oxide (ITO), indium zinc oxide (IZO) which is obtained by mixing zinc oxide (ZnO) into indium oxide, a conductive material in which silicon oxide (SiO₂) is mixed into indium oxide, organoindium, orgaonotin, indium oxide containing tungsten oxide, indium zinc oxide containing tungsten oxide, indium oxide containing titanium oxide, indium tin oxide containing titanium oxide, a metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), or silver (Ag), an alloy thereof, and a nitride thereof.

In the above-described manner, in the passive matrix liquid crystal display device using the liquid crystal layer exhibiting a blue phase, contrast ratio can be increased.

This embodiment can be implemented in combination with any of the structures described in the other embodiments as appropriate.

### Embodiment 11

When a thin film transistor is manufactured and used for a pixel portion and further for a driver circuit, a liquid crystal display device having a display function can be manufactured. Furthermore, when part or whole of a driver circuit is formed over the same substrate as a pixel portion with the use of a thin film transistor, a system-on-panel can be obtained.

A liquid crystal display device includes a liquid crystal element (also referred to as a liquid crystal display element) as a display element.

In addition, the liquid crystal display device includes a panel in which the display element is sealed, and a module in which an IC or the like including a controller is mounted on the panel. As for an element substrate which corresponds to a mode before the display element is completed in a manufacturing process of the liquid crystal display device, the element substrate is provided with means for supplying current to the display element in each of a plurality of pixels. Specifically, the element substrate may be in a state after only a pixel electrode of the display element is formed, a state after a conductive film to be a pixel electrode is formed and before the conductive film is etched to form the pixel electrode, or any of other states.

Note that a liquid crystal display device in this specification means an image display device, a display device, or a light source (including a lighting device). Furthermore, the liquid crystal display device also includes the following modules in its category: a module to which a connector such as an FPC (flexible printed circuit), a TAB (tape automated bonding) tape, or a TCP (tape carrier package) is attached; a module having a TAB tape or a TCP at the tip of which a printed wiring board is provided; and a module in which an IC (integrated circuit) is directly mounted on a display element by a COG (chip on glass) method.

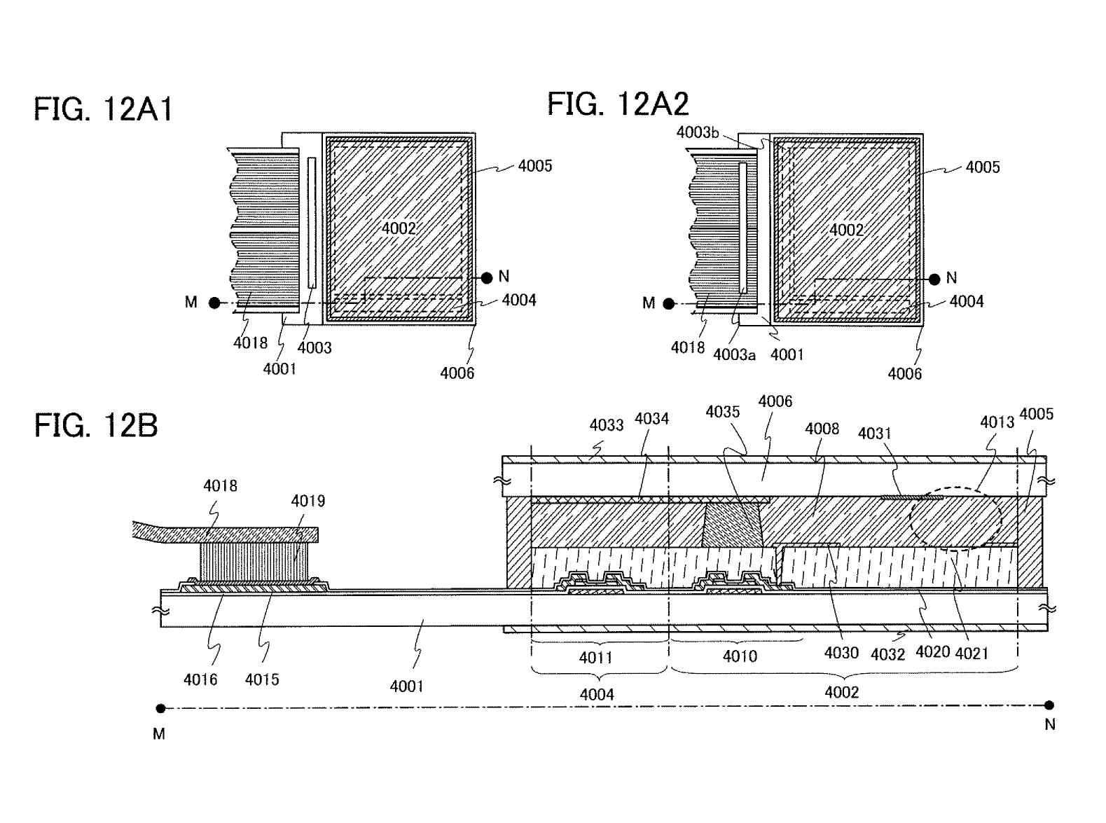

The appearance and a cross section of a liquid crystal display panel which corresponds to one mode of the liquid crystal display device will be described with reference to FIGS. 12A1, 12A2 and 12B. FIGS. 12A1 and 12A2 are each a top view of a panel in which thin film transistors 4010 and 4011 formed over a first substrate 4001 and a liquid crystal element 4013 are sealed between the first substrate 4001 and a second substrate 4006 with a sealant 4005. FIG. 12B is a cross-sectional view taken along line M-N of FIGS. 12A1 and 12A2.

The sealant 4005 is provided to surround a pixel portion 4002 and a scan line driver circuit 4004 that are provided over the first substrate 4001. The second substrate 4006 is provided over the pixel portion 4002 and the scan line driver circuit 4004. Therefore, the pixel portion 4002 and the scan line driver circuit 4004 are sealed together with a liquid crystal layer 4008 by the first substrate 4001, the sealant 4005, and the second substrate 4006.

In FIG. 12A1, a signal line driver circuit 4003 that is formed using a single crystal semiconductor film or a polycrystalline semiconductor film over a substrate separately prepared is mounted in a region different from the region surrounded by the sealant 4005 over the first substrate 4001. Note that FIG. 12A2 illustrates an example in which part of the signal line driver circuit is formed using a thin film transistor provided over the first substrate 4001. A signal line driver circuit 4003b is formed over the first substrate 4001, and a signal line driver circuit 4003a formed using a single crystal semiconductor film or a polycrystalline semiconductor film is mounted over a separately-prepared substrate.

Note that there is no particular limitation on the connection method of the driver circuit which is separately formed, and a COG method, a wire bonding method, a TAB method, or the like can be used. FIG. 12A1 illustrates an example of mounting the signal line driver circuit 4003 by a COG method, and FIG. 12A2 illustrates an example of mounting the signal line driver circuit 4003a by a TAB method.

The pixel portion 4002 and the scan line driver circuit 4004 provided over the first substrate 4001 each include a plurality of thin film transistors. FIG. 12B illustrates the thin film transistor 4010 included in the pixel portion 4002 and the thin film transistor 4011 included in the scan line driver circuit 4004. An insulating layer 4020 and an interlayer film 4021 are provided over the thin film transistors 4010 and 4011.

Any of the thin film transistors described in Embodiments 2 to 9 can be applied to the thin film transistors 4010 and 4011. The thin film transistors 4010 and 4011 are n-channel thin film transistors.

A pixel electrode layer 4030 is provided over the first substrate 4001, and the pixel electrode layer 4030 is electrically connected to the thin film transistor 4010. The liquid crystal element 4013 includes the pixel electrode layer 4030, a common electrode layer 4031, and the liquid crystal layer 4008. Note that a polarizing plate 4032 and a polarizing plate 4033 are provided on the outsides of the first substrate 4001 and the second substrate 4006, respectively. The common electrode layer 4031 is provided on the second substrate 4006 side, and the pixel electrode layer 4030 and the common electrode layer 4031 are stacked with the liquid crystal layer 4008 interposed therebetween.

Note that the first substrate 4001 and the second substrate 4006 can be formed using glass, plastic, or the like that has a light-transmitting property. As plastic, an FRP (fiberglass-reinforced plastics) plate, a PVF (polyvinyl fluoride) film, a polyester film, or an acrylic resin film can be used. Alternatively, a sheet with a structure in which an aluminum foil is sandwiched between PVF films or polyester films can be used.

A columnar spacer denoted by reference numeral 4035 is obtained by selectively etching an insulating film and is provided in order to control the thickness (the cell gap) of the liquid crystal layer 4008. Alternatively, a spherical spacer may be used. Note that in the liquid crystal display device using the liquid crystal layer 4008, it is preferable that the thickness (the cell gap) of the liquid crystal layer 4008 be approximately 5 μm to 20 μm.

FIGS. 12A1, 12A2, and 12B illustrate examples of a transmissive liquid crystal display device; however, this embodiment can also be applied to a semi-transmissive liquid crystal display device.

FIGS. 12A1, 12A2, and 12B illustrate an example of a liquid crystal display device in which a polarizing plate is provided on the outside of a substrate (on the viewing side); however, the polarizing plate may be provided on the inside of the substrate. The position of the polarizing plate may be determined as appropriate in accordance with the material of the polarizing plate or conditions of manufacturing steps. Furthermore, a light-blocking layer functioning as a black matrix may be provided.

The interlayer film 4021 is a light-transmitting chromatic color resin layer and functions as a color filter layer. Further, part of the interlayer film 4021 may serve as a light-blocking layer. In FIGS. 12A1, 12A2, and 12B, a light-blocking layer 4034 is provided on the second substrate 4006 side so as to cover the thin film transistors 4010 and 4011. By providing the light-blocking layer 4034, contrast can be further improved and the thin film transistors can be further stabilized.

The thin film transistor may be covered with the insulating layer 4020 functioning as a protective film thereof; however, the present invention is not particularly limited thereto.

Note that the protective film is provided to prevent entry of impurities floating in the air, such as an organic substance, a metal substance, or moisture, and is preferably a dense film. The protective film may be formed by a sputtering method to be a single-layer film or stacked layers of a silicon oxide film, a silicon nitride film, a silicon oxynitride film, a silicon nitride oxide film, an aluminum oxide film, an aluminum nitride film, an aluminum oxynitride film, or an aluminum nitride oxide film.

After the protective film is formed, the semiconductor layer may be subjected to annealing (at 300° C. to 400° C.).

In the case where a light-transmitting insulating layer is further formed as a planarizing insulating film, an organic material having heat resistance such as polyimide, acrylic, benzocyclobutene, polyamide, or epoxy can be used. Other than such organic materials, it is also possible to use a low-dielectric constant material (a low-k material), a siloxane-based resin, PSG (phosphosilicate glass), BPSG (borophosphosilicate glass), or the like. Note that the insulating layer may be formed by stacking a plurality of insulating films formed using these materials.

There is no particular limitation on the method for forming the insulating layer to be stacked, and the insulating layer can be formed, in accordance with the material, by a sputtering method, an SOG method, a spin coating method, a dip coating method, a spray coating method, a droplet discharging method (such as ink jetting, screen printing, or offset printing), a doctor knife, a roll coater, a curtain coater, a knife coater, or the like. In the case where the insulating layer is formed using a material solution, the semiconductor layer may be annealed (at 200° C. to 400° C.) at the same time of a baking step. The baking step of the insulating layer also serves as the annealing step of the semiconductor layer, whereby a liquid crystal display device can be manufactured efficiently.

The pixel electrode layer 4030 and the common electrode layer 4031 can be made of a light-transmitting conductive material such as indium oxide containing tungsten oxide, indium zinc oxide containing tungsten oxide, indium oxide containing titanium oxide, indium tin oxide containing titanium oxide, indium tin oxide (ITO), indium zinc oxide, or indium tin oxide to which silicon oxide is added.

The pixel electrode layer 4030 and the common electrode layer 4031 can be formed using one kind or plural kinds selected from metal such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), or silver (Ag); an alloy thereof; and a nitride thereof.

A conductive composition containing a conductive high molecule (also referred to as a conductive polymer) can be used for the pixel electrode layer 4030 and the common electrode layer 4031.

In addition, a variety of signals and potentials are supplied to the signal line driver circuit 4003 that is formed separately, and the scan line driver circuit 4004 or the pixel portion 4002 from an FPC 4018.

Further, since the thin film transistors are easily broken by static electricity or the like, a protection circuit for protecting the driver circuits is preferably provided over the same substrate for a gate line or a source line. The protection circuit is preferably formed using a nonlinear element.

In FIGS. 12A1, 12A2, and 12B, a connection terminal electrode 4015 is formed from the same conductive film as the pixel electrode layer 4030, and a terminal electrode 4016 is formed from the same conductive film as source electrode layers and drain electrode layers of the thin film transistors 4010 and 4011.

The connection terminal electrode 4015 is electrically connected to a terminal included in the FPC 4018 through an anisotropic conductive film 4019.

Note that an example in which the signal line driver circuit 4003 is separately formed and mounted over the first substrate 4001 is illustrated in FIGS. 12A1, 12A2, and 12B; however, this embodiment is not limited to this structure. The scan line driver circuit may be separately formed and mounted, or only part of the signal line driver circuit or part of the scan line driver circuit may be separately formed and mounted.

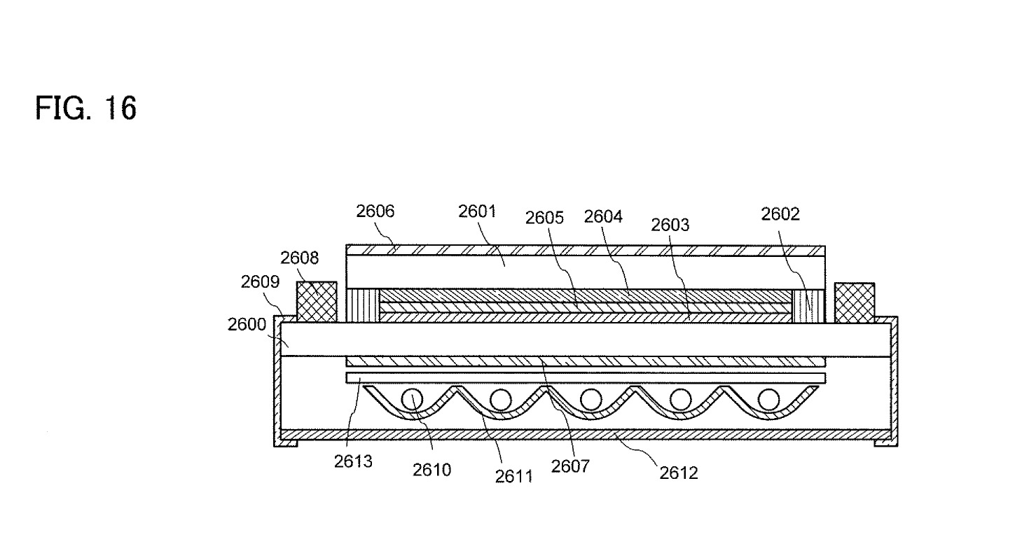

FIG. 16 illustrates an example of a liquid crystal display module formed as the liquid crystal display device disclosed in this specification.

FIG. 16 illustrates an example of the liquid crystal display module in which an element substrate 2600 and a counter substrate 2601 are firmly attached to each other by a sealant 2602, and an element layer 2603 including a TFT and the like, a display element 2604 including a liquid crystal layer, and an interlayer film 2605 including a light-transmitting chromatic color resin layer that functions as a color filter are provided between the substrates to form a display region. The interlayer film 2605 including a light-transmitting chromatic color resin layer is necessary to perform color display. In the case of the RGB system, light-transmitting chromatic color resin layers corresponding to respective colors of red, green, and blue are provided for respective pixels. A polarizing plate 2606, a polarizing plate 2607, and a diffusion plate 2613 are provided outside the element substrate 2600 and the counter substrate 2601. A light source includes a cold cathode tube 2610 and a reflective plate 2611. A circuit board 2612 is connected to a wiring circuit portion 2608 of the element substrate 2600 through a flexible wiring board 2609 and includes an external circuit such as a control circuit or a power source circuit. Alternatively, a diode emitting white light may be used as a light source. The polarizing plate and the liquid crystal layer may be stacked with a retardation plate interposed therebetween.

Through the above-described steps, a highly reliable liquid crystal display panel as a liquid crystal display device can be manufactured.

This embodiment can be implemented in combination with any of the structures described in the other embodiments as appropriate.

### Embodiment 12

The liquid crystal display device disclosed in this specification can be applied to a variety of electronic devices (including amusement machines). Examples of electronic devices are a television set (also referred to as a television or a television receiver), a monitor of a computer or the like, a digital camera, a digital video camera, a digital photo frame, a cellular phone (also referred to as a mobile phone or a mobile phone set), a portable game console, a portable information terminal, an audio reproducing device, a large-sized game machine such as a pachinko machine, and the like.

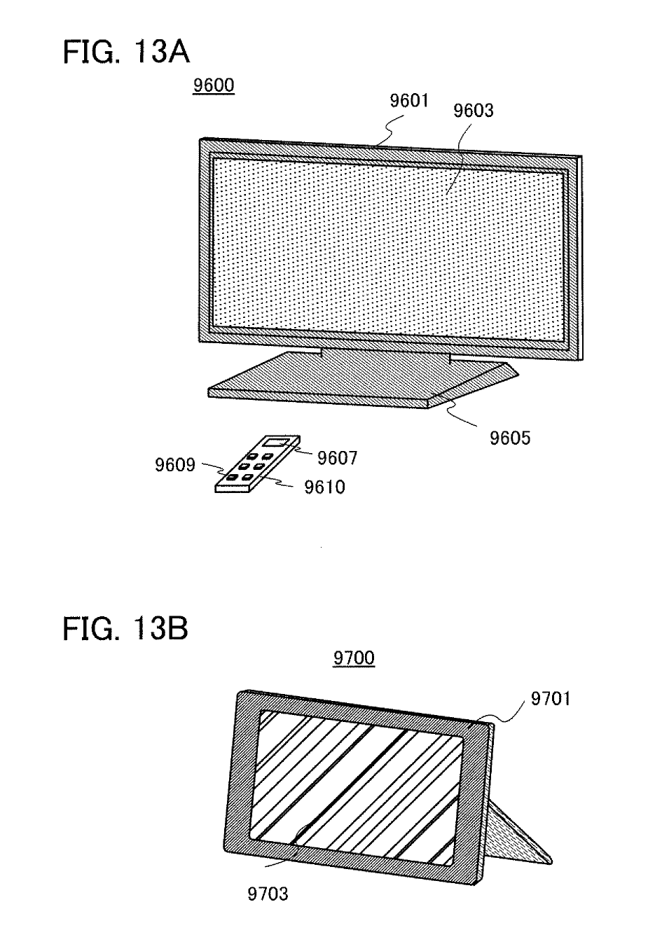

FIG. 13A illustrates an example of a television set 9600. In the television set 9600, a display portion 9603 is incorporated in a housing 9601. Images can be displayed on the display portion 9603. Here, the housing 9601 is supported by a stand 9605.

The television set 9600 can be operated with an operation switch of the housing 9601 or a separate remote controller 9610. Channels and volume can be controlled with an operation key 9609 of the remote controller 9610 so that an image displayed on the display portion 9603 can be controlled. Furthermore, the remote controller 9610 may be provided with a display portion 9607 for displaying data output from the remote controller 9610.

Note that the television set 9600 is provided with a receiver, a modem, and the like. With the receiver, a general television broadcast can be received. Furthermore, when the television set 9600 is connected to a communication network by wired or wireless connection via the modem, one-way (from a transmitter to a receiver) or two-way (between a transmitter and a receiver, between receivers, or the like) data communication can be performed.

FIG. 13B illustrates an example of a digital photo frame 9700. For example, in the digital photo frame 9700, a display portion 9703 is incorporated in a housing 9701. Various images can be displayed on the display portion 9703. For example, the display portion 9703 can display data of an image shot by a digital camera or the like to function as a normal photo frame.

Note that the digital photo frame 9700 is provided with an operation portion, an external connection terminal (such as a USB terminal, or a terminal that can be connected to various cables such as a USB cable), a recording medium insertion portion, and the like. Although they may be provided on the same surface as the display portion, it is preferable to provide them on the side surface or the back surface for the design of the digital photo frame 9700. For example, a memory storing data of an image shot by a digital camera is inserted in the recording medium insertion portion of the digital photo frame, whereby the image data can be downloaded and displayed on the display portion 9703.

The digital photo frame 9700 may have a structure capable of wirelessly transmitting and receiving data. Through wireless communication, desired image data can be downloaded to be displayed.

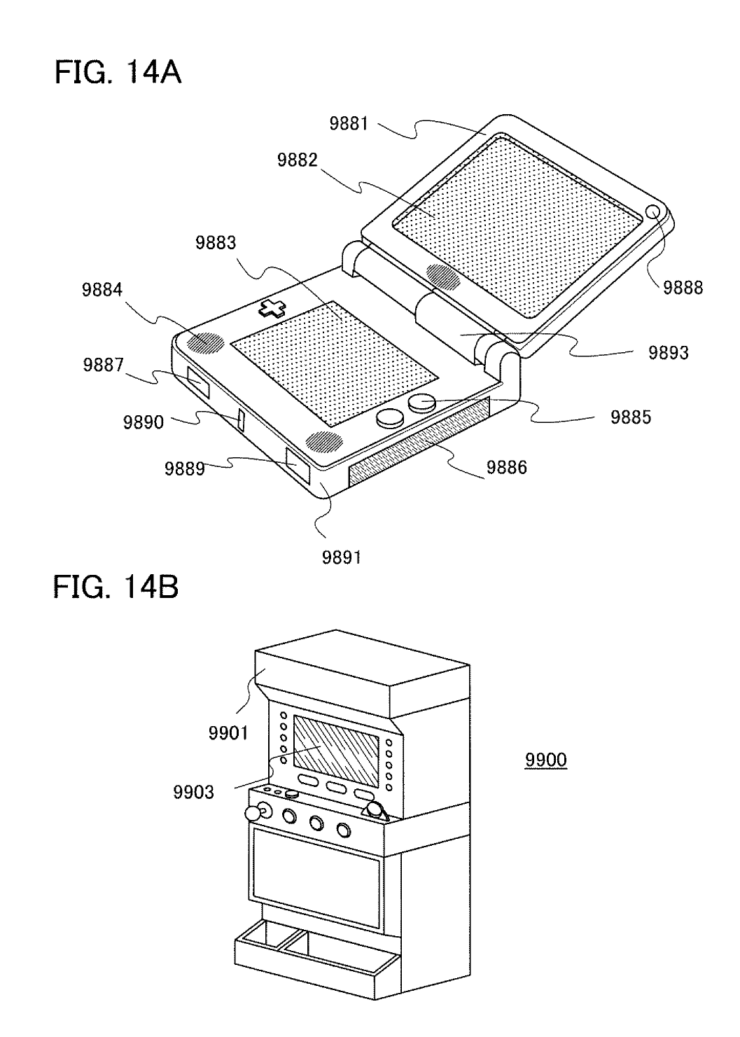

FIG. 14A illustrates a portable amusement machine including two housings: a housing 9881 and a housing 9891. The housings 9881 and 9891 are connected with a connection portion 9893 so as to be opened and closed. A display portion 9882 and a display portion 9883 are incorporated in the housing 9881 and the housing 9891, respectively. In addition, the portable amusement machine illustrated in FIG. 14A includes a speaker portion 9884, a recording medium insertion portion 9886, an LED lamp 9890, an input means (an operation key 9885, a connection terminal 9887, a sensor 9888 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), or a microphone 9889), and the like. It is needless to say that the structure of the portable amusement machine is not limited to the above and other structures provided with at least the liquid crystal display device disclosed in this specification can be employed. The portable amusement machine may include another accessory equipment as appropriate. The portable amusement machine illustrated in FIG. 14A has a function of reading a program or data stored in a recording medium to display it on the display portion, and a function of sharing information with another portable amusement machine by wireless communication. The portable amusement machine illustrated in FIG. 14A can have various functions without limitation to the above.

FIG. 14B illustrates an example of a slot machine 9900 which is a large-sized amusement machine. In the slot machine 9900, a display portion 9903 is incorporated in a housing 9901. In addition, the slot machine 9900 includes an operation means such as a start lever or a stop switch, a coin slot, a speaker, and the like. It is needless to say that the structure of the slot machine 9900 is not limited to the above and other structures provided with at least the liquid crystal display device disclosed in this specification may also be employed. The slot machine 9900 may include another accessory equipment as appropriate.

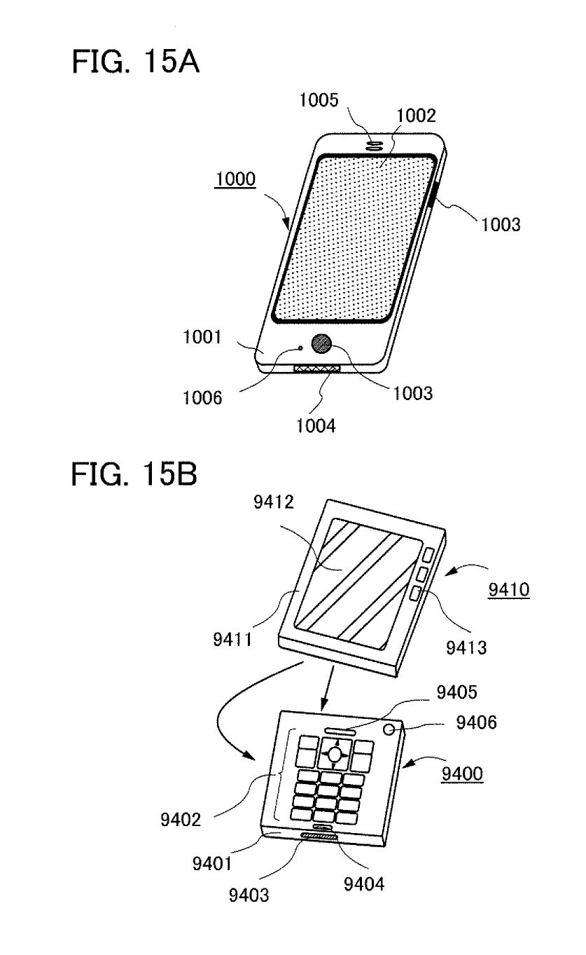

FIG. 15A illustrates an example of a cellular phone 1000. The cellular phone 1000 is provided with a display portion 1002 incorporated in a housing 1001, operation buttons 1003, an external connection port 1004, a speaker 1005, a microphone 1006, and the like.

When the display portion 1002 of the cellular phone 1000 illustrated in FIG. 15A is touched with a finger or the like, data can be input into the cellular phone 1000. Furthermore, operations such as making calls and composing mails can be performed by touching the display portion 1002 with a finger or the like.

There are mainly three screen modes of the display portion 1002. The first mode is a display mode mainly for displaying images. The second mode is an input mode mainly for inputting data such as text. The third mode is a display-and-input mode in which two modes of the display mode and the input mode are combined.

For example, in the case of making a call or composing a mail, a text input mode mainly for inputting text is selected for the display portion 1002 so that text displayed on a screen can be input. In that case, it is preferable to display a keyboard or number buttons on almost all the area of the screen of the display portion 1002.

When a detection device including a sensor for detecting inclination, such as a gyroscope or an acceleration sensor, is provided inside the cellular phone 1000, display on the screen of the display portion 1002 can be automatically switched by determining the direction of the cellular phone 1000 (whether the cellular phone 1000 is placed horizontally or vertically for a landscape mode or a portrait mode).

The screen mode is switched by touching the display portion 1002 or operating the operation buttons 1003 of the housing 1001. Alternatively, the screen mode can be switched depending on the kind of images displayed on the display portion 1002. For example, when a signal of an image displayed on the display portion is of moving image data, the screen mode is switched to the display mode. When the signal is of text data, the screen mode is switched to the input mode.

Furthermore, in the input mode, when input by touching the display portion 1002 is not performed for a certain period while a signal is detected by the optical sensor in the display portion 1002, the screen mode may be controlled so as to be switched from the input mode to the display mode.

The display portion 1002 may function as an image sensor. For example, an image of a palm print, a fingerprint, or the like is taken by touching the display portion 1002 with the palm or the finger, whereby personal authentication can be performed. Furthermore, by providing a backlight or a sensing light source emitting a near-infrared light for the display portion, an image of a finger vein, a palm vein, or the like can also be taken.

FIG. 15B illustrates another example of a cellular phone. The cellular phone in FIG. 15B has a display device 9410 in a housing 9411, which includes a display portion 9412 and operation buttons 9413, and a communication device 9400 in a housing 9401, which includes operation buttons 9402, an external input terminal 9403, a microphone 9404, a speaker 9405, and a light-emitting portion 9406 that emits light when a phone call is received. The display device 9410 which has a display function can be detached from or attached to the communication device 9400 which has a phone function by moving in two directions indicated by the allows. Thus, the display device 9410 and the communication device 9400 can be attached to each other along their short sides or long sides. In addition, when only the display function is needed, the display device 9410 can be detached from the communication device 9400 and used alone. Images or input information can be transmitted or received by wireless or wired communication between the communication device 9400 and the display device 9410, each of which has a rechargeable battery,

This application is based on Japanese Patent Application serial no. 2008-329656 filed with Japan Patent Office on Dec. 25, 2008, the entire contents of which are hereby incorporated by reference.

What is claimed is:

1. A liquid crystal display device comprising:
a first substrate and a second substrate between which a liquid crystal layer including a liquid crystal material exhibiting a blue phase is interposed;
a pixel electrode layer having an opening pattern, which is provided between the first substrate and the liquid crystal layer; and
a common electrode layer having an opening pattern, which is provided between the second substrate and the liquid crystal layer.

2. A liquid crystal display device according to claim 1, wherein the pixel electrode layer is in contact with the liquid crystal layer, and the common electrode layer is in contact with the liquid crystal layer.

3. A liquid crystal display device according to claim 1, wherein the pixel electrode layer and the common electrode layer each have a comb shape.

4. A liquid crystal display device according to claim 1, wherein the liquid crystal layer includes a chiral agent.

5. A liquid crystal display device according to claim 1, wherein the liquid crystal layer includes a photocurable resin and a photopolymerization initiator.

6. A liquid crystal display device according to claim 1,
wherein a thin film transistor is provided between the first substrate and the pixel electrode layer, and
wherein the pixel electrode layer is electrically connected to the thin film transistor.

7. A liquid crystal display device according to claim 6, wherein the thin film transistor includes an oxide semiconductor layer.

8. A liquid crystal display device according to claim 7, wherein the oxide semiconductor layer contains at least one of indium, zinc, and gallium.

9. A liquid crystal display device according to claim 6, wherein a light-transmitting chromatic color resin layer is provided between the thin film transistor and the pixel electrode layer.

10. A liquid crystal display device according to claim 1, wherein the liquid crystal display device is incorporated into one selected from the group consisting of a television set, a digital photo frame, a portable amusement machine, a slot machine, and a cellular phone

11. A liquid crystal display device comprising:
a first substrate and a second substrate between which a liquid crystal layer including a liquid crystal material exhibiting a blue phase is interposed;
a pixel electrode layer having an opening pattern, which is provided between the first substrate and the liquid crystal layer; and
a common electrode layer having an opening pattern, which partially overlaps with the pixel electrode layer and is provided between the second substrate and the liquid crystal layer.

12. A liquid crystal display device according to claim 11, wherein the pixel electrode layer is in contact with the liquid crystal layer, and the common electrode layer is in contact with the liquid crystal layer.

13. A liquid crystal display device according to claim 11, wherein the pixel electrode layer and the common electrode layer each have a comb shape.

14. A liquid crystal display device according to claim 11, wherein the liquid crystal layer includes a chiral agent.

15. A liquid crystal display device according to claim 11, wherein the liquid crystal layer includes a photocurable resin and a photopolymerization initiator.

16. A liquid crystal display device according to claim 11,
wherein a thin film transistor is provided between the first substrate and the pixel electrode layer, and
wherein the pixel electrode layer is electrically connected to the thin film transistor.

17. A liquid crystal display device according to claim 16, wherein the thin film transistor includes an oxide semiconductor layer.

18. A liquid crystal display device according to claim 17, wherein the oxide semiconductor layer contains at least one of indium, zinc, and gallium.

19. A liquid crystal display device according to claim 16, wherein a light-transmitting chromatic color resin layer is provided between the thin film transistor and the pixel electrode layer.

20. A liquid crystal display device according to claim 11, wherein the liquid crystal display device is incorporated into one selected from the group consisting of a television set, a digital photo frame, a portable amusement machine, a slot machine, and a cellular phone
